(19) United States
(12) Patent Application Publication
(10) Pub. No.: US 2025/0033906 A1
(43) Pub. Date: Jan. 30, 2025

(54) DISPENSER FOR NESTABLE PALLETS

(71) Applicant: QTEK DESIGN LTD., Los Angeles, CA (US)

(72) Inventors: Paul Redman, London (CA); Jacob van Lanen, London (CA); Edward Mills, Thorndale (CA)

(21) Appl. No.: 18/784,314

(22) Filed: Jul. 25, 2024

Related U.S. Application Data
(60) Provisional application No. 63/529,237, filed on Jul. 27, 2023.

(51) Int. Cl. B65G 59/06; B65D 19/00

(52) U.S. Cl. CPC B65G 59/06; B65D 19/0004; B65D 2519/00034; B65D 2519/00069; B65D 2519/0094; B65G 2201/0267

(57) ABSTRACT

A nestable pallet dispenser for a stack of nestable pallets, the dispenser having a frame defining a holding area for the stack of nestable pallets; a pair of pallet clamps mounted to the frame on opposing sides, operable to clamp the stack of nestable pallets in a closed clamp position. The dispenser further includes a movable support frame movably connected to the frame; and a pair of retractable bottom support plates mounted to the movable frame on opposing sides and below the pair of pallet clamps. The moveable frame is operable in an extended support position and a retracted support position, and for supporting a nestable pallet from the stack of nestable pallets in the extended support position. Dispensed pallets may be removed via an indexer or a gravity conveyor.

### FIELD OF THE INVENTION

The present specification relates generally to a pallet dispenser, and more particularly to a pallet dispenser for nestable pallets.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

Almost every product in the world is shipped on a pallet. For years, most pallets have been made from wood, with a few made from steel, aluminum, cardboard and/or plastic. Plastic is the most common pallet material after wood, however, cost has affected its popularity. Plastic pallets have evolved, and a popular style has become the nestable pallet. It allows for the pallets to become nested one into the other vertically, such that an 8-foot stack of nestable plastic pallets could contain up to 40 to 55 pallets. A comparable 8-foot stack of traditional wood pallets would contain 17 to 21 pallets. The advantage of having nestable pallets is that return transportation costs are greatly reduced. Plastic also has advantages over wood in being lighter and having a reduced risk of contamination and therefore have become a popular choice for food companies. Thus, plastic pallets are increasing in popularity and use.

Traditionally, a forklift driver places a 4 to 5-foot stack of nestable pallets on a warehouse floor. The warehouse order picker pulls up beside the stack in a forklift, pallet jack or similar machine, gets off their lift, removes the top pallet off the stack and places it either of the floor or directly on top of the forks of their pallet jack or lifter.

Warehouses are continuously improving their efficiency, and having the order picker build multiple pallets at a time is becoming increasingly common. This process requires the order picker to pick multiple pallets off the top of the stack and to have a machine with longer forks to allow multiple pallets on the pallet jack.

Accordingly, there remains a need for improvements in the art.

### SUMMARY OF THE INVENTION

In accordance with an aspect of the invention, there is provided a nestable pallet dispenser for a stack of nestable pallets and a method of using the same.

According to an embodiment of the invention, there is provided a nestable pallet dispenser for a stack of nestable pallets, the dispenser comprising a frame defining a holding area for the stack of nestable pallets; a pair of pallet clamps mounted to the frame on opposing sides, the pallet clamps operable in an open clamp position and a closed clamp position, and for clamping the stack of nestable pallets in the closed clamp position. The dispenser further comprises a movable support frame movably connected to the frame and a pair of retractable bottom support plates mounted to the movable frame on opposing sides and below the pair of pallet clamps, the support plates operable in an extended support position and a retracted support position, and supporting a nestable pallet from the stack of nestable pallets in the extended support position.

The dispenser may further comprise powered cylinders for movably connecting the movable support frame with the frame, with the movable support frame movable to a stack support position, a pallet support position, and a dispense support position. In an embodiment the movable support frame may be u-shaped with a left side, a right side, and a rear side, and four powered cylinders located at the corners of the movable support frame for movably connecting the movable support frame to the frame.

The dispenser may still further comprise ejectors mounted to the frame adjacent to and on each side of the pair of pallet clamps, the ejectors operable in an extended ejector position and a retracted ejector position, and urging a bottom nestable pallet away from the stack of nestable pallets in the extended ejector position. In an embodiment, the ejector ejects in the extended ejector position by pushing on a deck of the bottom nestable pallet. In another embodiment, the ejector comprises an ejector powered cylinder; and the extended ejector position is caused by extension of the ejector powered cylinder, and the retracted ejector position is caused by retraction of the ejector powered cylinder.

The powered cylinders may be a pneumatic cylinder, a hydraulic cylinder, or an electric cylinder. In an embodiment, each of the powered cylinders may comprise a first pneumatic cylinder and a second pneumatic cylinder fixedly connected and arranged to extend away from each other. In this embodiment, the stack support position is defined by extension of the first pneumatic cylinder and extension of the second pneumatic cylinder; the pallet support position is defined by the retraction of the first pneumatic cylinder and extension of the second pneumatic cylinder; and the dispense support position is defined by the retraction of the first pneumatic cylinder and retraction of the second pneumatic cylinder.

The pallet support position of the movable frame corresponds with the pair of pallet clamps clamping in the closed clamp position at least a second from the bottom nestable pallet of the nestable pallet stack, and the bottom nestable pallet of the pallet stack is not clamped. In an embodiment, the pallet support position is a nesting pitch below the stack support position, and the dispense support position is about 1 inch below the pallet support position.

The dispenser may further comprise a metallic finger attached to the moveable support frame for indicating the support position of the movable frame and still further comprise magnetic proximity sensors on the frame for detecting the metallic finger for determining the support position of the movable frame.

Each of the bottom support plates may comprise a support plate connected to a linear rail and a plate powered cylinder, the linear rail and the plate powered cylinder mounted to the movable support frame. In this embodiment, the extended support position of the bottom support plate is caused by extension of the plate powered cylinder; and the retracted support position of the bottom support plate is caused by retraction of the plate powered cylinder.

Each of the pair of pallet clamps may comprise a plate, a linkage, and a clamp powered cylinder, the plate connected through the linkage to the frame, and the plate connected through the clamp powered cylinder to the frame. In this embodiment, the open clamp position of the pair of pallet clamps is caused by retraction of the clamp powered cylinder; and the closed clamp position of the pair of pallet clamps is caused by extension of the clamp powered cylinder.

In a still further embodiment, a pallet dispensed area is defined as underneath the nestable pallet dispenser and below the holding area. The pallet dispenser may then further comprise a stack photo-eye for detecting the stack of nestable pallets; a bottom photo-eye for detecting the bottom nestable pallet; and a dispensed photo-eye for detecting a dispensed pallet in the pallet dispensed area.

The nestable pallet dispenser may be set to a support the pallet stack configuration, the configuration comprising: the pair of retractable bottom support plates are in the extended support position and the movable support frame is at the stack support position; the pair of pallet clamps are in the open clamp position; and the ejectors are in the retracted ejector position.

The nestable pallet dispenser may be set to a preparing to dispense configuration, the configuration comprising: the pair of retractable bottom support plates are in the extended support position and the movable support frame is at the pallet support position; the pair of pallet clamps are in the closed clamp position; and the ejectors are in the retracted ejector position.

The nestable pallet dispenser may be set to a dispense configuration, the configuration comprising: the pair of retractable bottom support plates are in the retracted support position and the movable support frame is at the dispense support position; the pair of pallet clamps are in the closed clamp position; and the ejectors are in the retracted ejector position.

Thus, when the nestable pallet dispenser is set to the dispense configuration, and the bottom photo-eye detects the presence of the bottom nestable pallet, then cycling the ejectors through the extended ejector position and the retracted ejector position, for ejecting and dispensing the bottom nestable pallet into the pallet dispensed area.

In yet another embodiment, the dispenser may include a conveyor photo-eye adjacent to the pallet dispensed area working with the dispensed photo-eye for starting and stopping operation of the nestable pallet dispenser.

According to a further embodiment of the invention, there is provided a method for dispensing nestable pallets, the method comprising: clamping by a pair of pallet clamps in a closed clamp position a penultimate bottom pallet, wherein a bottom pallet is not clamped, the penultimate bottom pallet and the bottom pallet in a stack of nestable pallets; supporting the bottom pallet on a pair of bottom support plates in an extended support position and a movable support frame in a pallet support position.

The method may further comprise lowering the movable support frame to a dispense support position for lowering the bottom support plates for reducing stack pressure between the bottom pallet and the penultimate pallet and detecting with a dispensed sensor that there is no pallet on a working surface.

The method may still further comprise retracting the bottom support plate to the retracted support position for letting the bottom pallet fall to the working surface; detecting with the dispensed sensor if the bottom pallet has fallen to the working surface; if the dispensed sensor does not detect the bottom pallet on the working surface, then activating ejectors to an extended ejector position for pushing the bottom pallet onto the working surface.

The method may further comprise detecting with the dispensed sensor that the bottom pallet is on the working surface; extending the bottom support plates to the supported position; and raising the movable support frame to the stack support position for supporting the penultimate bottom pallet which is now the bottom pallet. The detecting step may also comprise detecting with the dispensed sensor that the bottom pallet is on the working surface, and, detecting with a bottom sensor that the bottom pallet has fallen. Where the ejectors are activated more than once; then a fault may be triggered if the bottom sensor and the dispensed sensor are both blocked.

The method may still further comprise retracting the clamps to the open clamp position; supporting the stack of nestable pallets on the bottom support plates; and lowering the movable support frame to the pallet support position. The distance between the stack support position and pallet support position may be one nesting pitch of the stack of nestable pallets.

The method may comprise detecting with the dispensed sensor that the bottom pallet is on the working surface, and detecting with a conveyor sensor that a dispensed pallet is blocking the conveyor sensor, then, pausing the dispensing.

Any or all of the sensors may be photo-eyes.

According to a further embodiment of the invention, there is provided a gravity conveyor for pallets, the conveyor comprising: a first end for receiving a pallet with legs and a deck, comprising; a support rail for slidably supporting a bottom of the legs; a guide rail for receiving a subset of the legs and guiding the pallet along the length of the first end of the gravity conveyor towards a second end; a support frame for connecting the first end to the second end; the second end for dispensing the pallet from a dispensing end, the dispensing end opposite the first end, comprising: a pair of upper guide rails for slidably supporting bottom edges of the deck and guiding the pallet along the length of the gravity conveyor toward the dispensing end; and a stop at the dispensing end for stopping the pallet from sliding by blocking one of the legs. The conveyor may be configured to support 4 to 7 pallets.

According to an embodiment, the support rail is a pair of support rails that run parallel to the guide rail, and the pair of support rails are on both sides of the guide rail. The guide rail is a pair of parallel walls spaced apart to receive the subset of the legs between the pair of parallel walls. The support rail and the pair of upper guide rails may have an upper surface with a low friction coating, rollers, or both.

The first end and the second end may each be sloped at an angle for conveying the pallet from the first end to the dispensing end by gravity. The first end and the second end may each be sloped at the same angle. The conveyor may further comprise a set of supports attached to the first end, the second end, or both for supporting the first end and the second at the angle.

According to a further embodiment, the conveyor may further comprise a blocker placed perpendicularly to the upper guide rails and at the dispensing end for preventing collision with the pallets, the conveyor, or both. The conveyor may still further comprise a bumper on the first end, opposite the dispensing end, for urging the pallet towards the dispensing end.

The pallet may be supported by the bottom of the legs by the support rail of the first end, and transition to the pallet being supported by the bottom edges of the deck by the pair of upper guide rails of the second end.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 (PRIOR ART) is a perspective view of a nestable pallet and a stack of nestable pallets;

FIG. 2A is a perspective view of a nestable pallet dispenser according to an embodiment;

FIG. 2B is an alternate perspective view of FIG. 2A, with an embodiment of an optional gravity conveyor;

FIG. 3A is a detailed perspective view of a nestable pallet dispenser without retaining walls according to an embodiment;

FIG. 3B is a closeup side view of FIG. 3A;

FIG. 3C is a perspective view of FIG. 3B;

FIG. 3D is a front view of FIG. 3A with the moveable support frame in the stack support position;

FIG. 3E is an isolation view of a dual pneumatic cylinder in a fully extended position;

FIG. 3F is a front view of FIG. 3A with the moveable support frame in the pallet support position;

FIG. 3G is an isolation view of a dual pneumatic cylinder in a partially extended position;

FIG. 3H is a front view of FIG. 3A with the bottom frame in the pallet dispense position or dispense support position and the bottom support plates retracted;

FIG. 3I is an isolation view of a dual pneumatic cylinder in a fully retracted position;

FIG. 3J is a front view of FIG. 3A with the bottom frame in the pallet dispense position and the bottom support plates extended;

FIG. 4 is an isolated perspective view of the movable frame;

FIG. 5A is a closeup front perspective view of a side of the moveable frame with the bottom support plate extended;

FIG. 5B is a cutaway view of FIG. 5A with the bottom support plate removed;

FIG. 5C is a closeup front perspective view of a side of the nestable pallet dispenser with the bottom support plate retracted;

FIG. 5D is a cutaway view of FIG. 50;

FIG. 6A is a perspective view of a nestable pallet dispenser according to an embodiment;

FIG. 6B is a perspective view of a side of the nestable pallet dispenser;

FIG. 6C is a detailed view of 6B.

FIG. 6D is a perspective view of a side of the nestable pallet dispenser

FIG. 6E is a perspective view of a side of the nestable pallet dispenser with the clamp plate removed.

FIG. 6F is a detailed side view of the clamp in a open clamp position;

FIG. 6G is a detailed side view of the clamp in a closed clamp position;

FIG. 6H is a front view of an embodiment of the nestable pallet dispenser with a stack of pallets;

FIG. 7A a front view of a nestable pallet dispenser according to an embodiment;

FIG. 7B is a front view of a nestable pallet dispenser with an optional gravity conveyor according to an embodiment;

FIG. 7C is a perspective view of a gravity conveyor according to an embodiment;

FIGS. 8A to 8K illustrate a dispense cycle according to an embodiment of a method for dispensing a nestable pallet;

FIG. 9A to 9F illustrate an index cycle of an optional indexer according to an embodiment;

FIG. 10A is a perspective view of a gravity conveyor according to an embodiment;

FIG. 10B is an overhead view of FIG. 10A.

FIG. 10C is a side view of FIG. 10A;

FIGS. 11A to 11H illustrates a convey cycle of an optional gravity conveyor according to an embodiment;

FIG. 12A is a detailed view of the dispensing end of a gravity conveyor according to an embodiment showing a stopped nestable pallet;

FIG. 12B is a detailed view of the dispensing end of a gravity conveyor according to an embodiment;

FIG. 12C is a detailed view of the transition of support for the nestable pallet of a gravity conveyor according to an embodiment;

FIG. 13A is a side perspective view of an embodiment of the pallet dispenser and optional gravity conveyor with pallets loaded for pickup;

FIG. 13B is a side perspective view as in FIG. 13A, with pallets engaged by a material handler;

FIG. 13C is a side perspective view as in FIG. 13A, with pallets lifted by a material;

FIG. 13D is a side perspective view as in FIG. 13A, with pallets removed by a material; and

FIG. 14 is a schematic diagram of an embodiment of the pneumatic circuit.

Like reference numerals indicated like or corresponding elements in the drawings.

### LISTING OF FIGURE ELEMENTS

100—nestable pallet
110—deck
120—legs
130—stack of nestable pallets
140—nesting pitch
200—nestable pallet dispenser
210—frame/support frame
215—holding area
220—stack guards
230—opening
240—conveyor
250—clamps
255—clamp plate
260—clamp pneumatic cylinder/clamp powered cylinder
270—linkage
280—working surface
300—moveable support frame
302—left side
304—right side
306—rear side
308—front opening
310—bottom support plates
315—linear rail
320—plate pneumatic cylinder/plate powered cylinder
330—metallic finger
332—metallic finger
340—upper magnetic sensor
342—middle magnetic sensor
344—lower magnetic sensor
350—pneumatic cylinder/powered cylinder
352—first pneumatic cylinder
354—second pneumatic cylinder
360—adjustment bolt
600—bottommost pallet/bottom pallet
610—ejectors
620—ejector pneumatic cylinder/ejector powered cylinder
630—second bottommost pallet/penultimate pallet
640—ejector finger
710—stack photo-eye
715—stack photo-eye beam
720—bottom photo-eye
725—bottom photo-eye beam
730—dispensed photo-eye
735—dispensed photo-eye beam
900—indexer
910—pusher plate
920—extendable arm
930—indexer pneumatic cylinder/indexer powered cylinder
950—dispensed pallet
1010—side rails
1020—center rail
1030—conveyor photo-eye
1040—conveyor photo-eye beam
1050—stopper
1060—side rollers
1070—end rail
1080—bumper
1090—blocker
1300—material handler
1310—forklift arms
1400—Computer/PLC

### DETAILED DESCRIPTION OF THE EMBODIMENTS

The present invention relates to a pallet dispenser and, in particular, a pallet dispenser for nestable pallets.

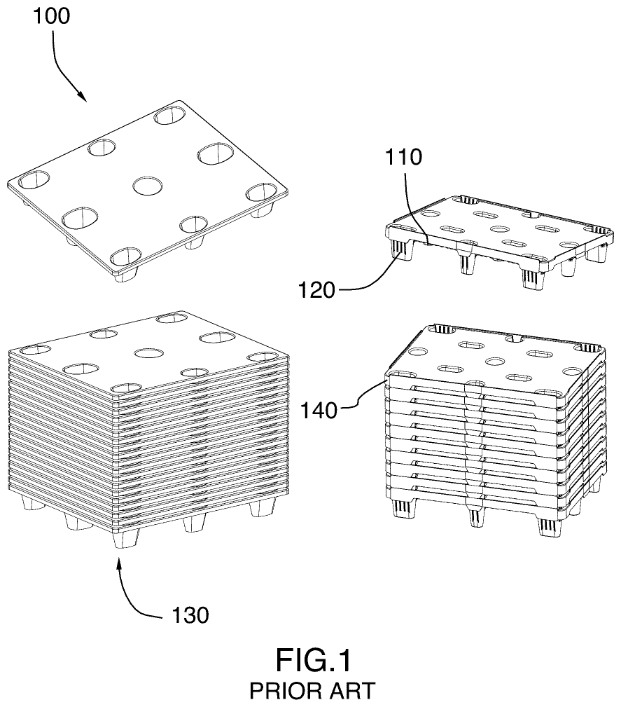

Referring to FIG. 1, as is known in the art, a nestable pallet 100 is comprised of a deck 110 and a plurality of legs 120, wherein the legs 120 are nestable within each other to minimize the distance between adjacent decks 110 when the pallets 100 are formed into a stack 130 of nestable pallets 100. The number of legs 120 may be varied, however, the most common designs have nine legs 120 arranged in a 3×3 square or rectangular configuration. Within stack 130 the distance between the decks 110 of the adjacent pallets 100 is known as the nesting pitch 140. FIG. 1 shows 2 different types of nestable pallets.

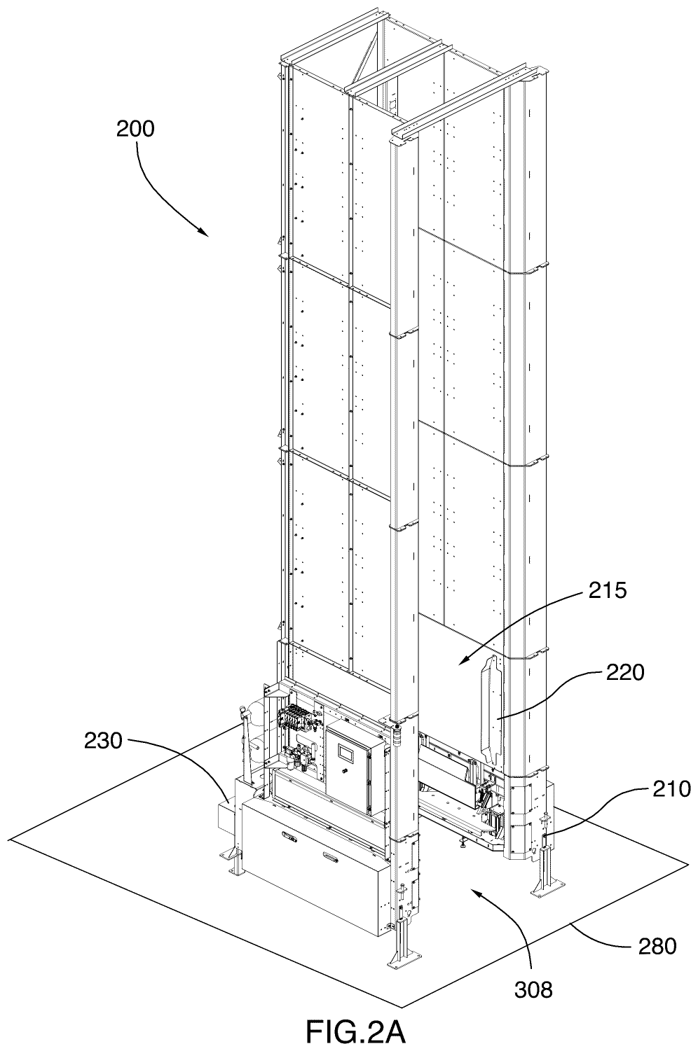

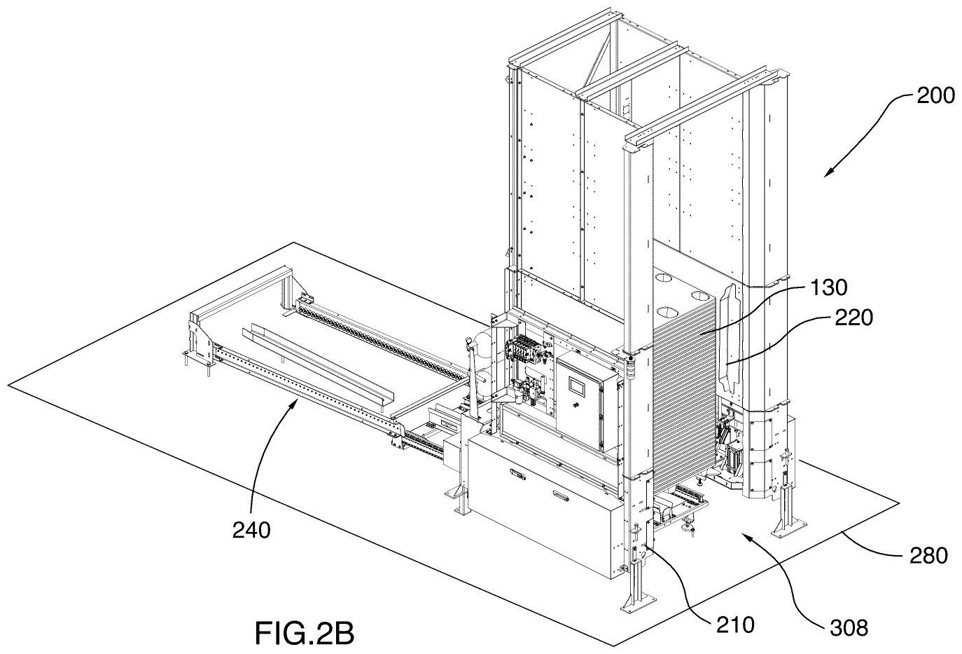

Referring to an embodiment as shown in FIGS. 2A-2B, a nestable pallet dispenser 200 holds a stack 130 of nestable pallets 100 for individual dispensing. The pallets 100 are held in a support frame 210 defining a holding area 215, with stack guards 220 positioned along the sides to keep the stack of nestable pallets 130 in place within the holding area 215. The support frame 210 is secured to a working surface 280. The pallets 100 are dispensed vertically onto working surface 280 which may be the ground, a platform, or a conveyor 240, as shown in FIG. 2B. The stack of nestable pallets 100 is loaded from the front opening 308. The difference in height between FIGS. 2A and 2B are due to the number of sections of the retaining walls being shown. The number of sections of the retaining walls may be varied to hold a different amount of pallets. In an embodiment, the retaining walls are for cooperating with the nestable pallet dispenser for holding the pallets.

The nestable pallet dispenser 200 operates to dispense individual pallets 100 from the stack of pallets 130, which may then be retrieved through front opening 308 or from an optional gravity conveyor 240 that passes through opening 230. The nestable pallet 100 is dispensed vertically onto working surface 280.

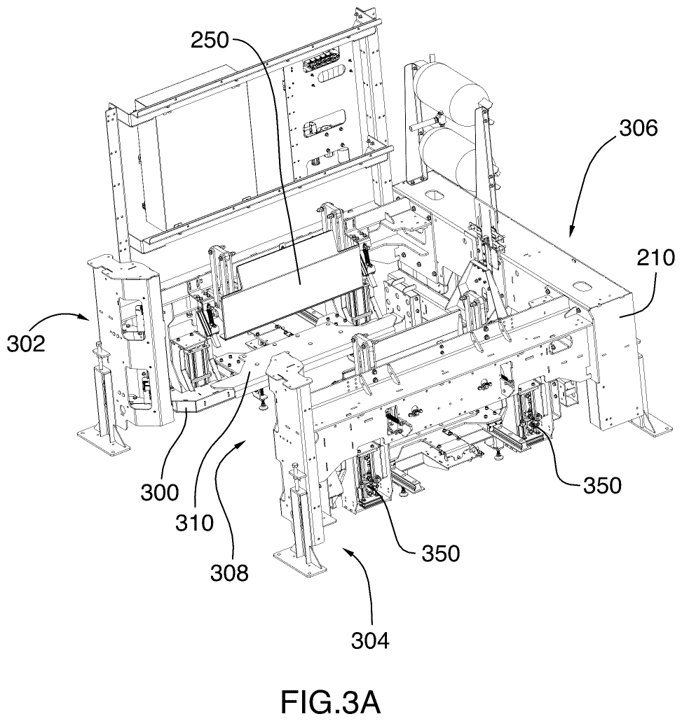

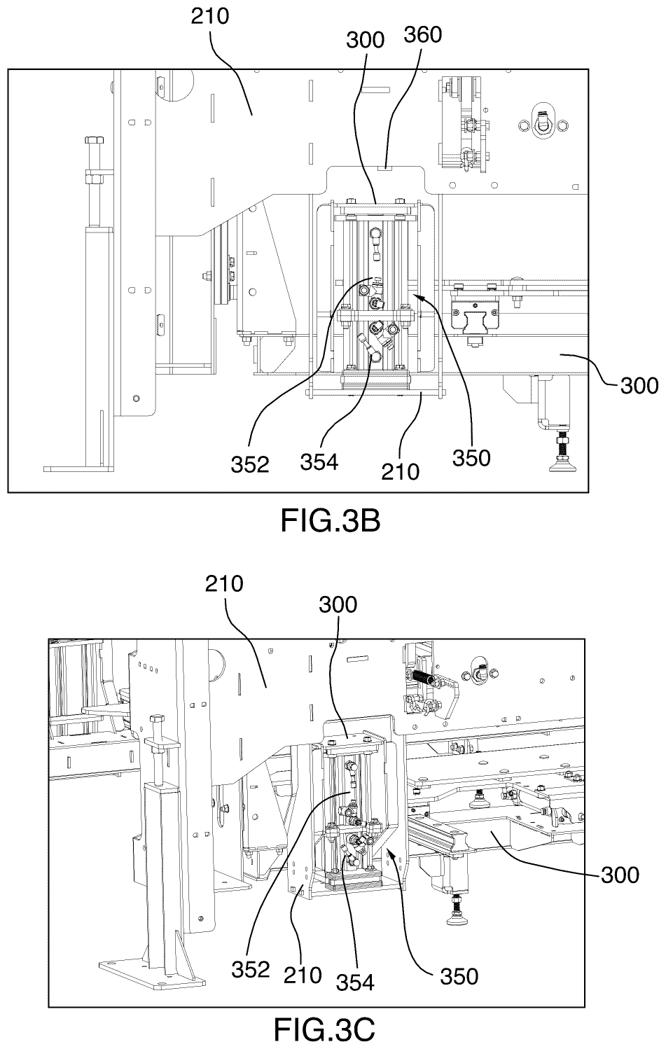

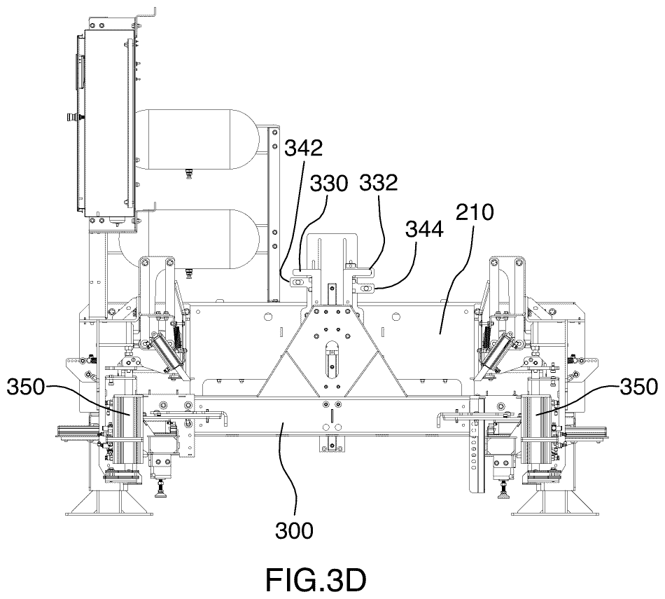

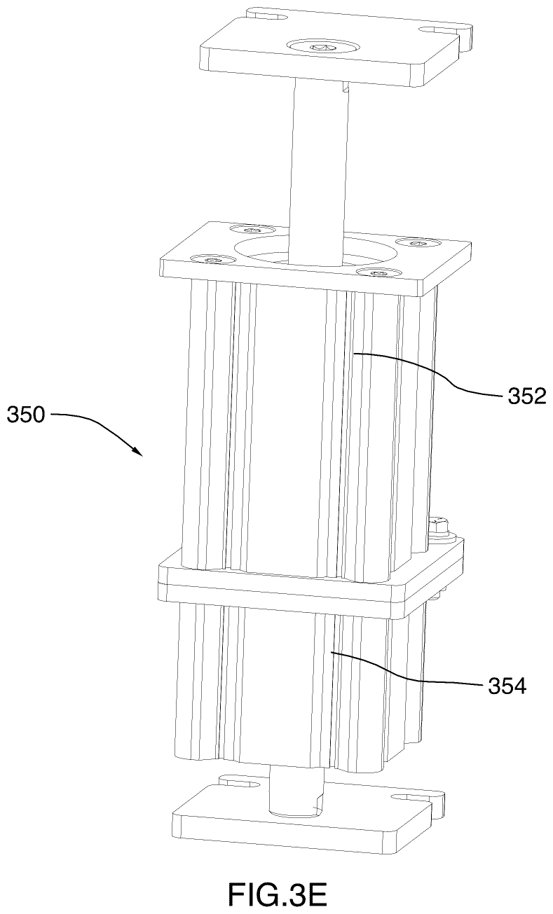

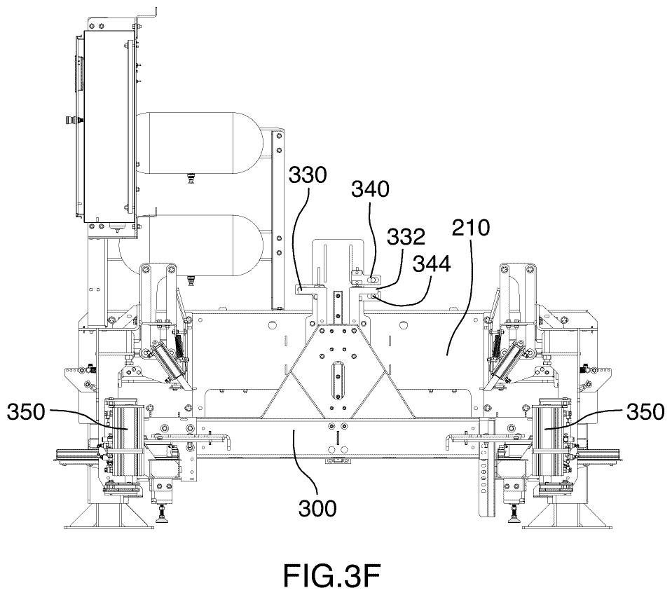

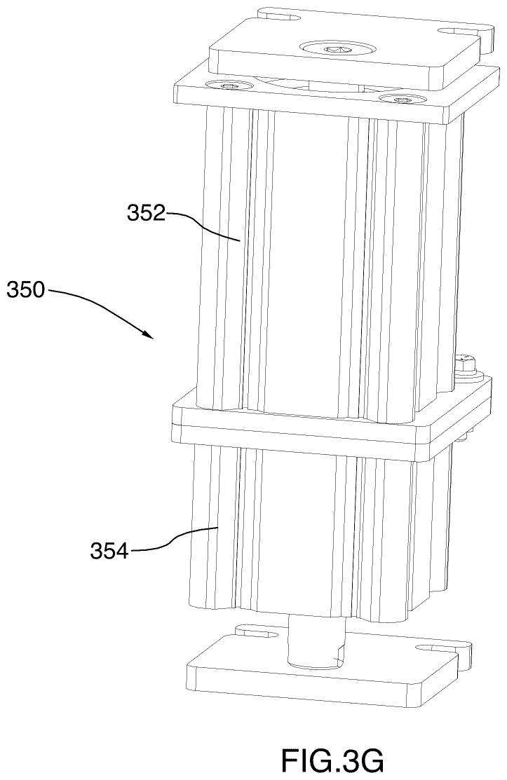

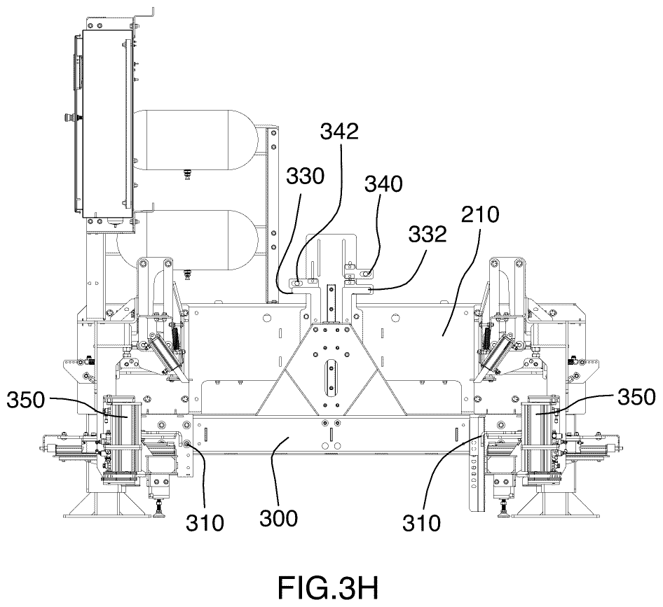

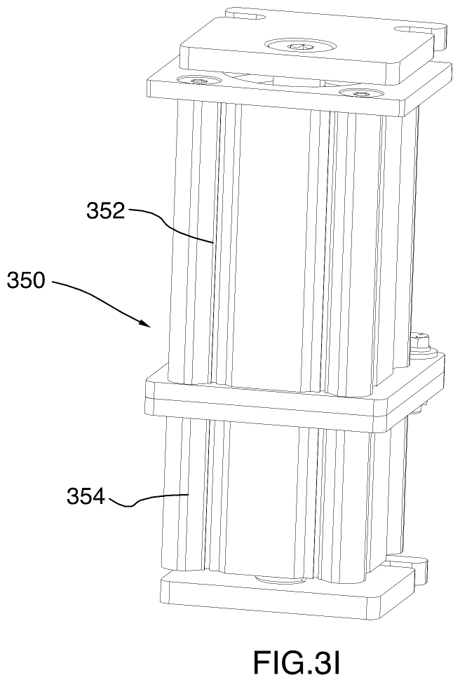

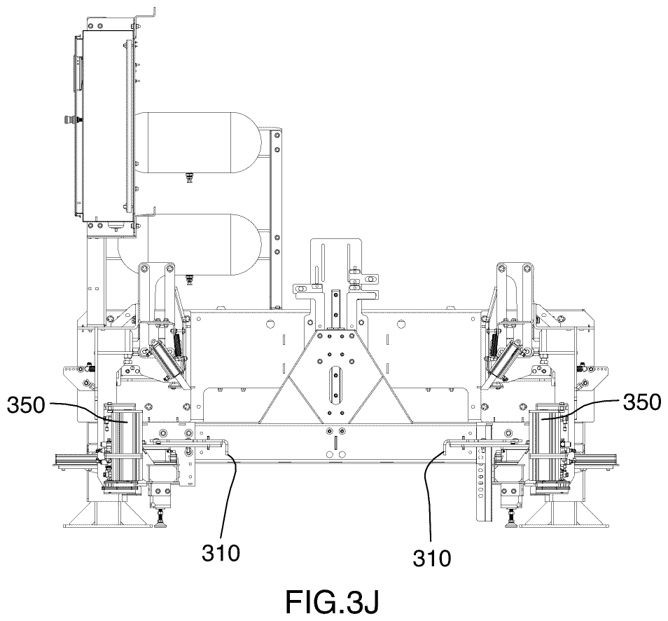

Referring to FIG. 3A, a moveable support frame 300 is movably secured to and positioned within the support frame 210. The moveable support frame 300 is shown in greater detail in FIGS. 3A-3J. The moveable support frame 300 is generally U-shaped, with a left side 302, a right side 304 and a rear side 306, and a front opening 308 to permit insertion of the stack of nestable pallets 130. Moveable support frame 300 has a pair of retractable bottom support plates 310 with one mounted to the left side 302 and the other mounted to the right side 304 of the moveable support frame 300. The retractable bottom support plates 310 are operable to move between an extended support position (as in FIG. 3J) and a retracted support position (as in FIG. 3H). Bottom support plates 310 support the legs 120 of the bottommost pallet 600 when in the extended support position.

Movable support frame 300 is moveably connected to the frame 210 by pneumatic cylinders 350. The moveable support frame 300 is moveable between three vertical positions via the pneumatic cylinders 350 for moving the bottom support plates 310 between three vertical positions (shown in detail in FIGS. 3E, 3G and 3I). Each pneumatic cylinder 350 is formed from a first pneumatic cylinder 352 and a second pneumatic cylinder 354, with the first pneumatic cylinder 352 having a greater extension length than second pneumatic cylinder 354. As shown, there are four pneumatic cylinders 350, with one pneumatic cylinder 350 located at each corner of moveable support frame 300.

The pneumatic cylinders 350 may more generally be powered cylinders in another embodiment. For example, in another embodiment, they may be hydraulic cylinders or electric cylinders. That is powered hydraulically or by electricity. Depending on the type of powered cylinder, they may further comprise 1 cylinder or 2 cylinders. The other powered cylinders, in other embodiments, may also be pneumatic cylinders, hydraulic cylinders, or electric cylinders. The powered cylinders are also known as actuators. In an embodiment, the pneumatic cylinder is a pneumatically actuator. In another embodiment, the hydraulic cylinder is a hydraulic actuator. In a further embodiment, the electric cylinder is an electric actuator.

Referring to FIGS. 3B and 3C, the second pneumatic cylinder 354 is fixed to the frame 210, and the frame 210 does not move as it is fixedly mounted to the working surface 280. The first pneumatic cylinder 352 is fixed to the moveable support frame 300. When the pneumatic cylinders are extended, the moveable support frame 300 moves upwards, and when the pneumatic cylinders are retracted, the moveable support frame 300 moves downwards. A single pneumatic cylinder may be used in an embodiment, however, it is a technical problem to reliably extend a pneumatic cylinder an arbitrary distance versus the reliability of full extension and full retraction of a pneumatic cylinder. Therefore, for improving reliability and precision of movement, the pneumatic cylinder 350 comprises a first pneumatic cylinder 352 and a second pneumatic cylinder 354 of the appropriate length for the vertical movement of the movable support frame 300. In other words, 2 pneumatic cylinders are used versus 1 pneumatic cylinder because of the accuracy needed to stop the pneumatic cylinder in the exact mid position. An air cylinder cannot easily be stopped in mid-motion. The first pneumatic cylinder is about the length of a nesting pitch 140, and the second pneumatic cylinder 354 is about 1 inch for relieving stack pressure on the bottom pallet.

The first position for the moveable support frame 300 is the stack support position, as shown in FIG. 3D. In this position, pneumatic cylinders 350 are in a fully extended position, as shown in FIG. 3E. A metallic finger 330 covers an upper magnetic sensor 340 to trigger upper magnetic sensor 340 to provide a signal that the movable support frame 300 is in the stack support position. Other types of position sensors could alternatively be used.

The second position for the moveable support frame 300 is the pallet support position, as shown in FIG. 3F. In this position, pneumatic cylinders 350 are in a partially extended position, as shown in FIG. 3G, with first pneumatic cylinder 352 retracted and second pneumatic cylinder 354 extended. A metallic finger 330 covers a middle magnetic sensor 342 to trigger middle magnetic sensor 342 to provide a signal that the movable support frame 300 is in the pallet support position. Again, other types of position sensors could alternatively be used.

The third position for the moveable support frame 300 is the pallet dispense position, as shown in FIG. 3H. In this position, pneumatic cylinders 350 are in a fully retracted position, as shown in FIG. 3I. Metallic finger 332 covers a lower magnetic sensor 344 to trigger lower magnetic sensor 344 to provide a signal that the movable support frame 300 is in the stack support position. Again, other types of position sensors could alternatively be used.

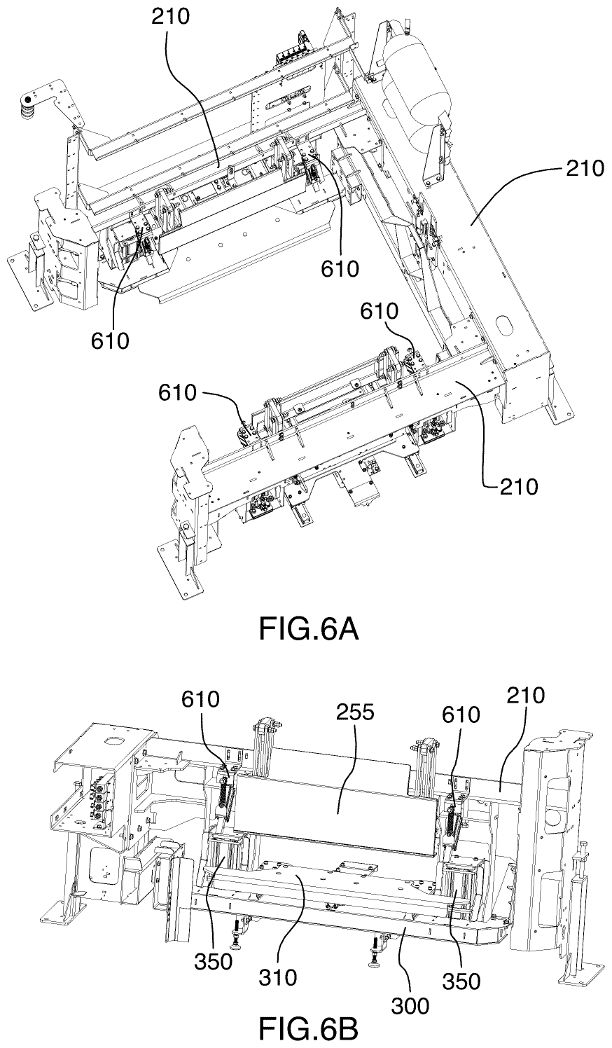

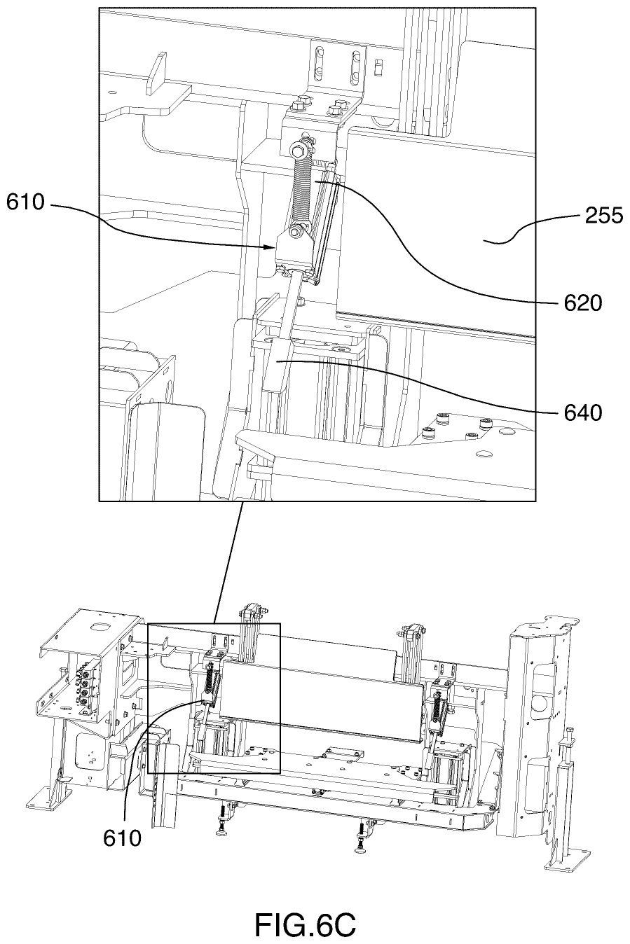

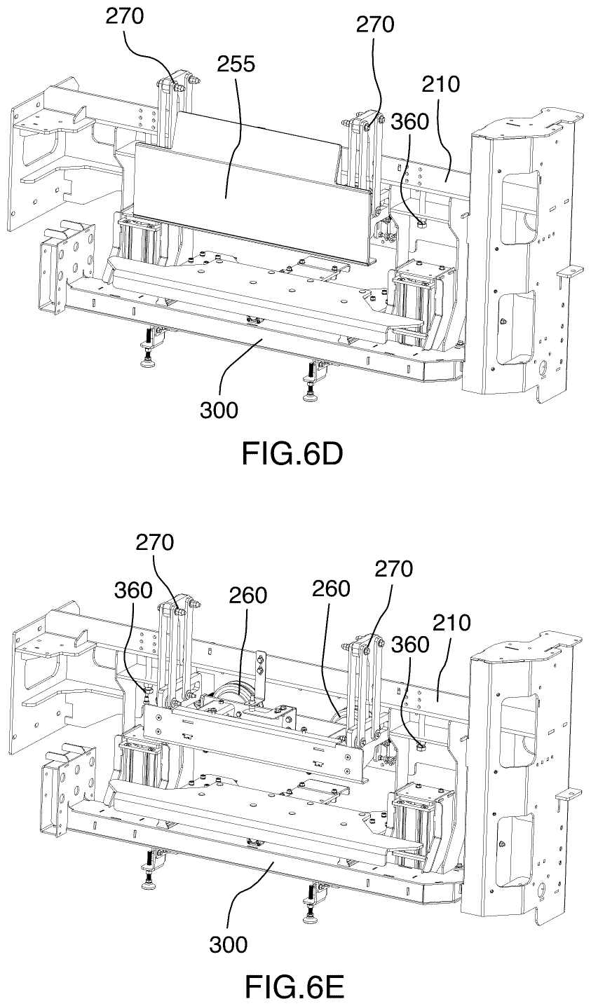

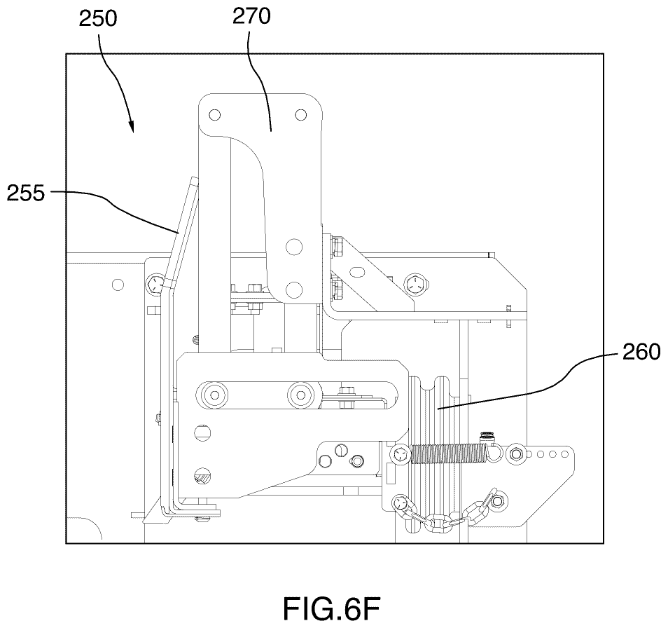

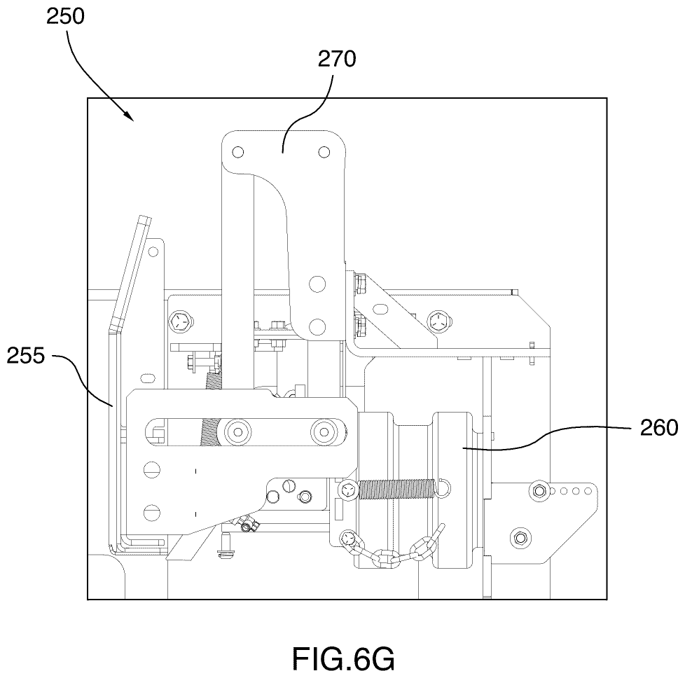

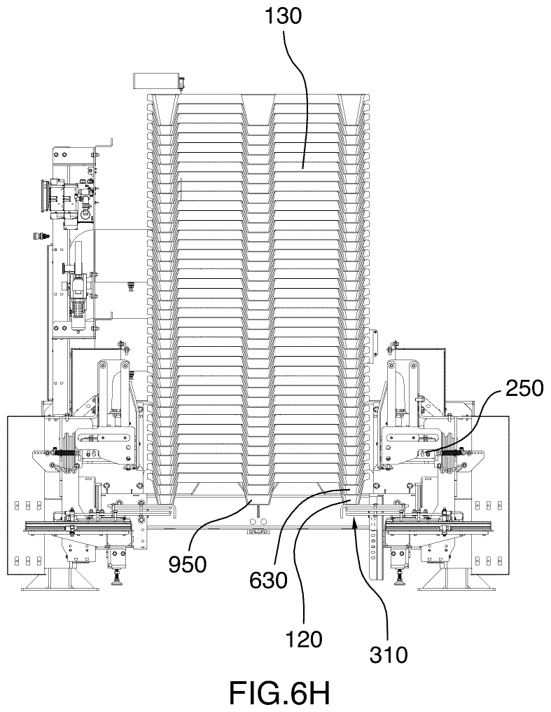

The distance between the stack support position and the pallet support position is determined by the nesting pitch 140 of pallets 100. Referring to FIGS. 3B, 6D and 6E, the specific height of the nesting pitch 140 is adjustable by an adjustment bolt 360 descending from the frame 210 above the moveable support frame 300 that prevents further movement of the moveable support frame 300 upwards.

In the pallet dispense position, the bottom support plates 310 may further be moved between an extended support position, as shown in FIG. 3J (and FIGS. 3D and 3F), into a retracted support position, as shown in FIG. 3H. The extended support position allows for stack of pallets 130 or pallet 100 to be supported by bottom support plates 310, and the retracted position allows for pallet 100 to be dispensed from the stack 130 of pallets.

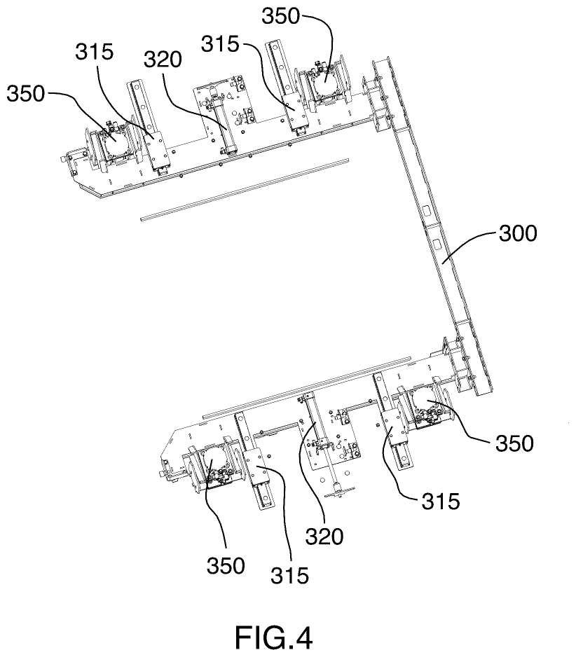

For greater clarity, an isolated exploded view of the moveable support frame is shown in FIG. 4. Shown are the position of the 4 pneumatic cylinders 350.

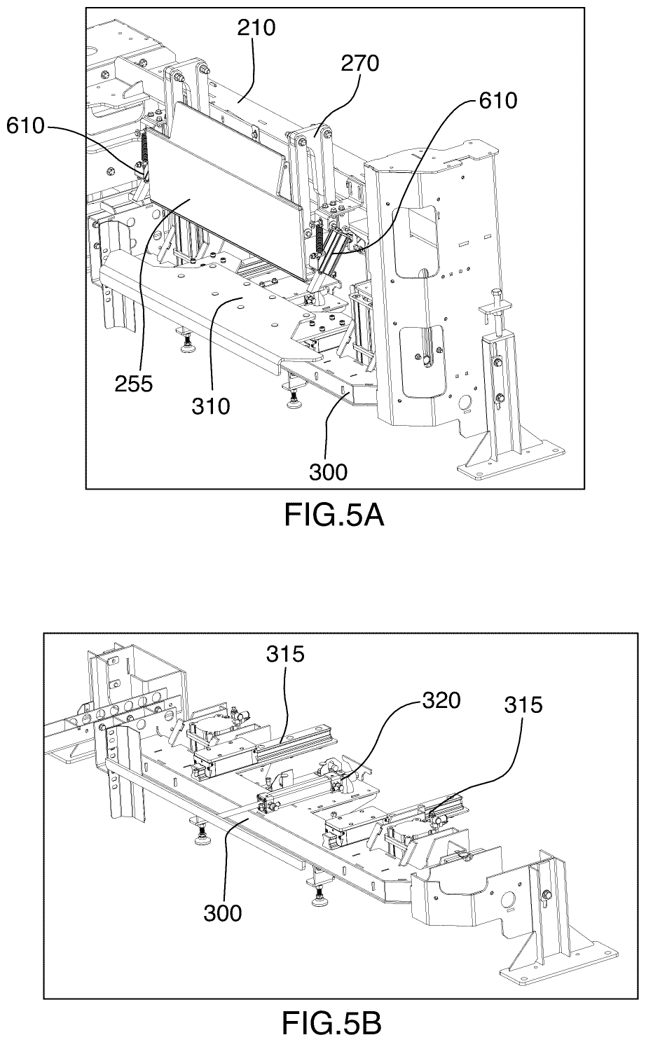

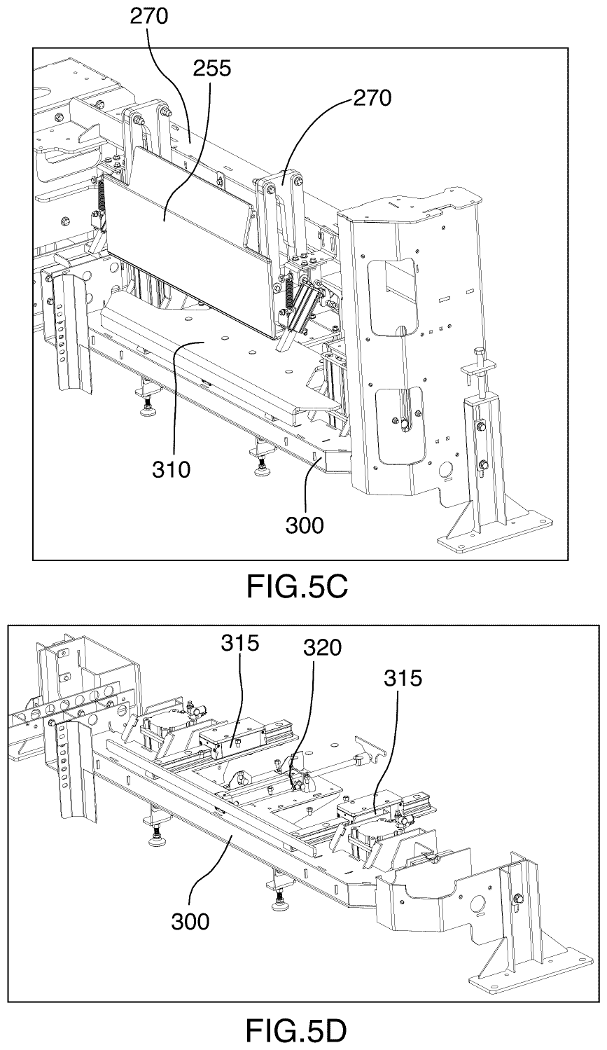

Referring to FIGS. 5A-5D, the bottom support plates 310 are each supported by and moveable along linear rails 315 secured to moveable support frame 300. Movement of the bottom support plates 310 along linear rails 315 between the extended support position (FIGS. 5A/5B) and the retracted support position (FIGS. 5C/5D) is provided via a pair of plate pneumatic cylinders 320, each secured to the moveable support frame 300.

Referring to FIGS. 6A-6H, moveable support frame 300 operates in cooperation with clamps 250 and ejectors 610 to support and dispense pallets 100 from a stack of pallets 130 within support frame 210. The ejectors 610 are located on either side of clamp plate 255. The ejectors are mounted to the frame 210. Ejectors 610 comprise a ejector pneumatic cylinder 620 and a ejector finger 640.

Clamps 250 are formed from a clamp plate 255 which is movable linearly between a retracted position (FIG. 6F) and an extended position (FIG. 6G) via clamp pneumatic cylinders 260. Clamp plate 255 is secured to frame 210 via linkage 270. Clamp pneumatic cylinders 260 are connected to clamp plate 255 and frame 210. Clamp plates 255 may have a rubberized surface to help with holding the pallet stack 130. Clamp plates 255 may have a bottom support lip that is about 1 cm in width (and extends past the rubberized surface, if any) for supporting deck 110 of the to be clamped pallet.

According to an embodiment, in the stack support position for the moveable support frame 300, the stack of pallets 130 are supported by bottom support plates 310 and clamps 250 are retracted. When moveable support frame 300 operates in the pallet support position, the bottommost pallet 600 in the stack 130 continues to rest upon the bottom support plates 310 and clamps 250 engage the stack 130 of pallets 100 at the second bottommost pallet 630 in the stack 130. When moveable support frame 300 is in the pallet dispense position, the clamps 250 continue to engage and support the stack of pallets 130 from the second bottommost pallet 630, and the bottommost pallet 600 is supported by the bottom support plates 310. With the movement of moveable frame 300 to the pallet dispense position, the bottommost pallet 600 disengages from the stack of pallets 130 for relieving stack pressure, and is dispensed by the retraction of bottom support plates 310 which enables the bottommost pallet 600 to fall onto the working surface 280 via gravity. If the bottommost pallet 600 is not properly disengaged from the stack 130, ejectors 610 (shown in detail in FIG. 6C) positioned on either side of clamps 250 may extend ejector fingers 640 via ejector pneumatic cylinders 620 to contact the deck of the bottommost pallet 600 with sufficient force to disengage bottommost pallet 600 properly from the stack of pallets 130. The ejector fingers 640 are then retracted into their original position.

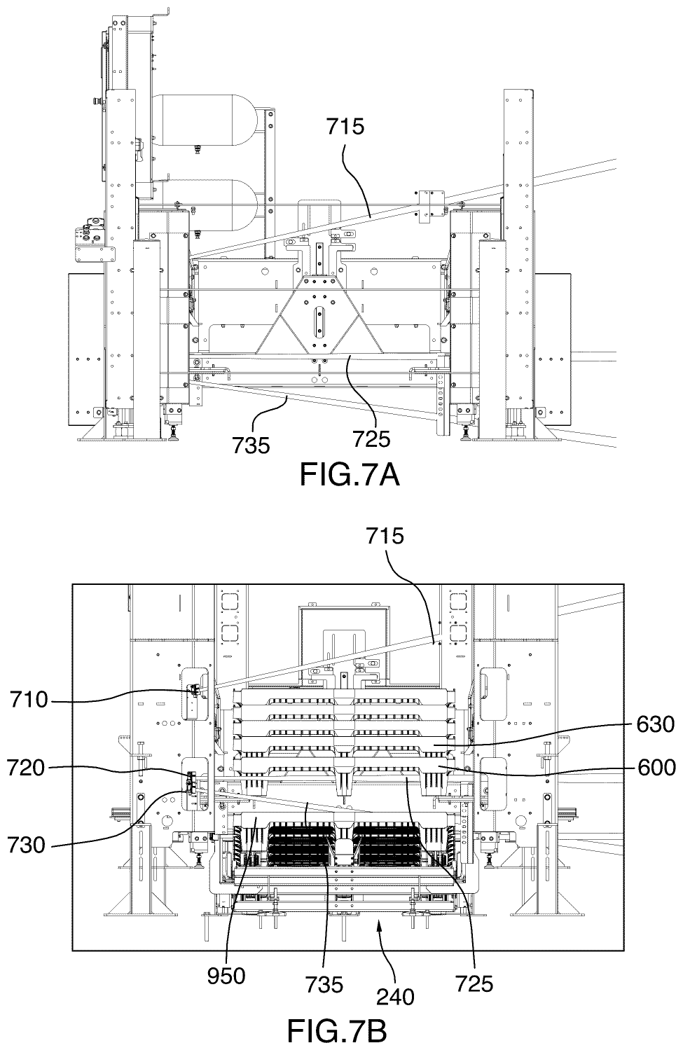

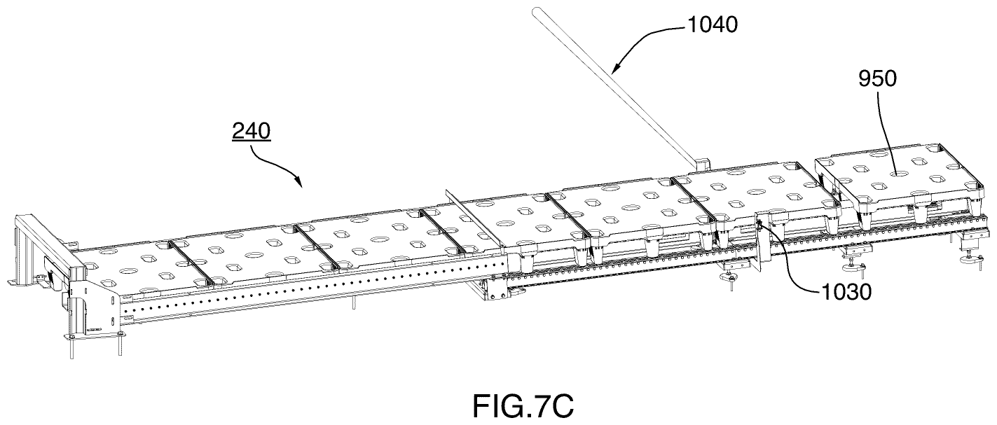

Tracking the location and the state of the pallets 100 is provided by a series of photo-eyes 710, 720, 730 coupled to support frame 210 as shown in FIGS. 7A-7C. The photo-eye beams 715, 725, and 735 are shown extending farther in the figures for ease of understanding. A stack photo-eye 710 is mounted on support frame 210 to detect the presence of a stack of pallets 130 within support frame 210 ready for dispensing. Stack photo-eye beam 715 projects from stack photo-eye 710 across support frame 210 through the space occupied by the stack 130 of pallets 100. When the stack photo-eye beam 715 is disrupted by a stack 130 of pallets 100, a signal is provided to indicate the presence of the stack 130 of pallets 100 for dispensing. If the beam 715 is not disrupted then no stack of pallets 130 is detected and operation of the machine is stopped.

A bottom photo-eye 720 is mounted on support frame 210 in a position above the bottom support plates 310 and below clamps 250. Bottom photo-eye 720 detects the presence of a bottommost pallet 600 in the stack of pallets 130. Bottom photo-eye beam 725 projects from bottom photo-eye 720 across support frame 210 through the space occupied by a pallet 100 or bottommost pallet 600 when supported by the bottom support plates 310. When the bottom photo-eye beam 725 is disrupted by a pallet 100 or bottommost pallet 600, a signal is provided to indicate the presence of a pallet 100 for dispensing. Also, in another use, the bottom photo-eye beam 725 may detect a bottommost pallet 600 that has failed to dispense properly.

A dispensed photo-eye 730 is mounted on support frame 210 in a position below bottom support plates 310. Dispensed photo-eye 730 detects the presence of a pallet 100 or dispensed pallet 950 on the working surface 280, after pallet 100 has been dispensed. Dispensed photo-eye beam 735 projects from dispensed photo-eye 730 across support frame 210 through the working surface 280 occupied by a pallet 100 or dispensed pallet 950 after being dispensed from the stack of pallets 130. When the dispensed photo-eye beam 735 is disrupted by a pallet 100 or dispensed pallet 950, a signal is provided to indicate the presence of a pallet 100 or dispensed pallet 950 on the working surface 280.

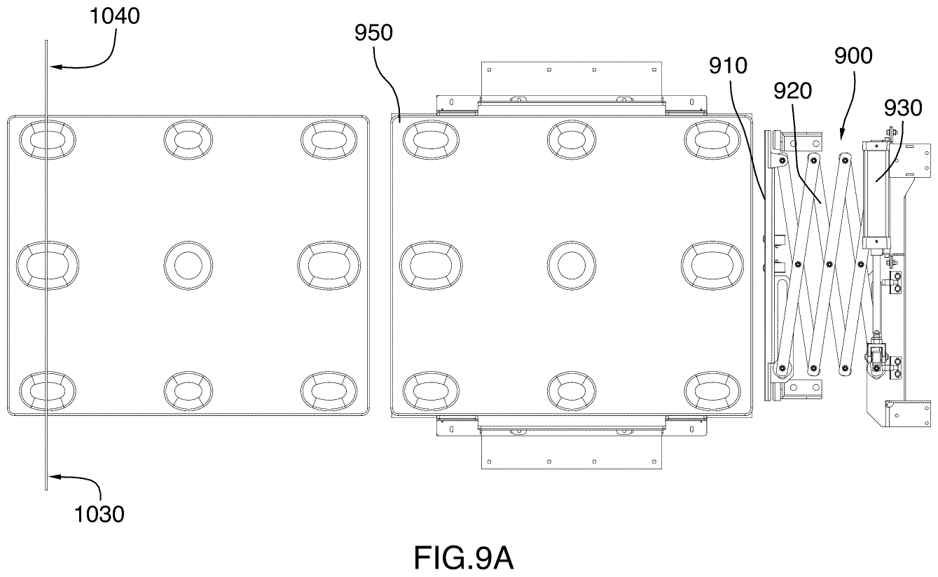

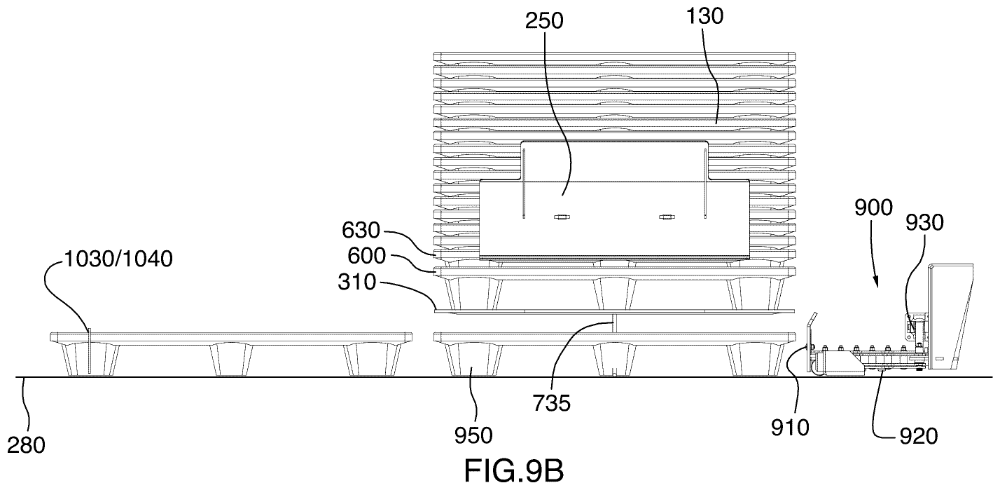

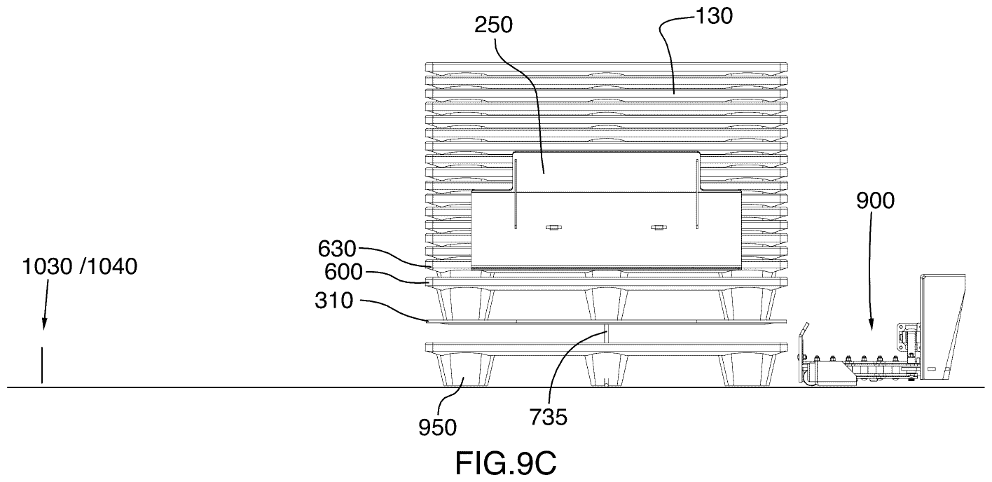

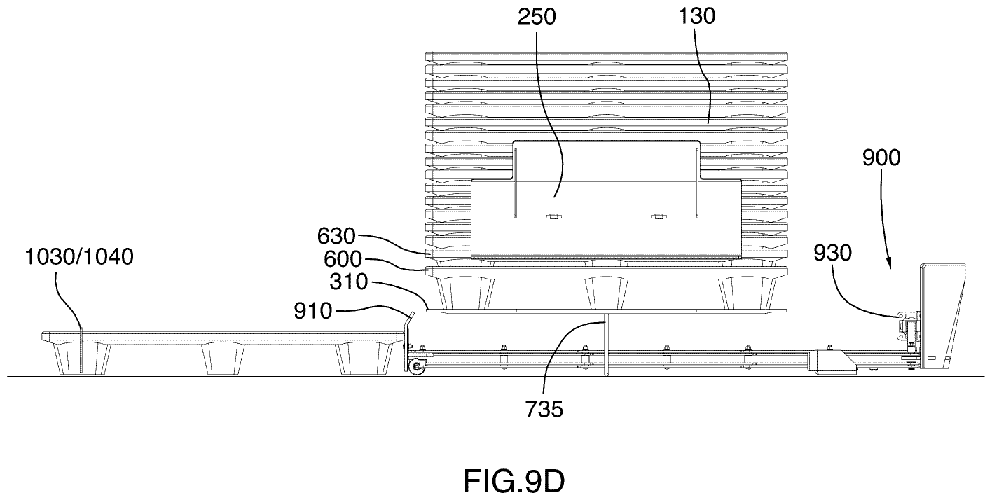

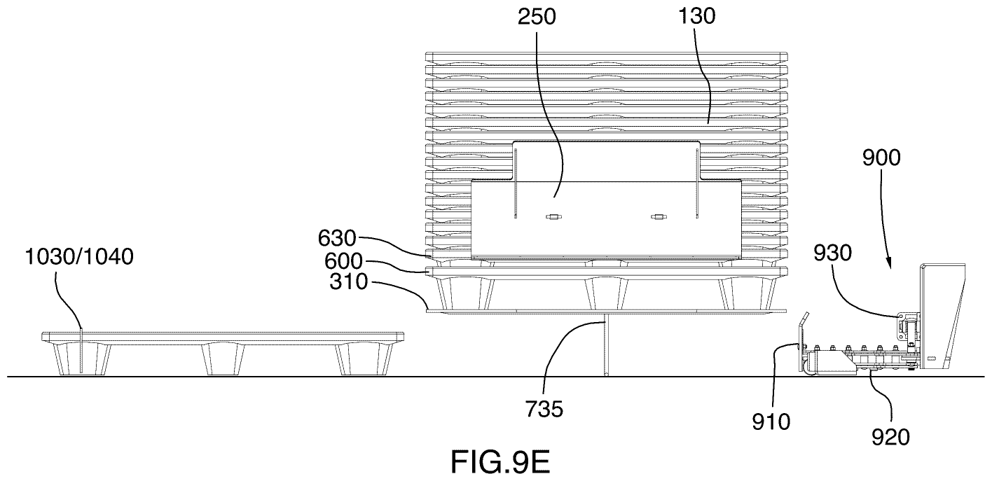

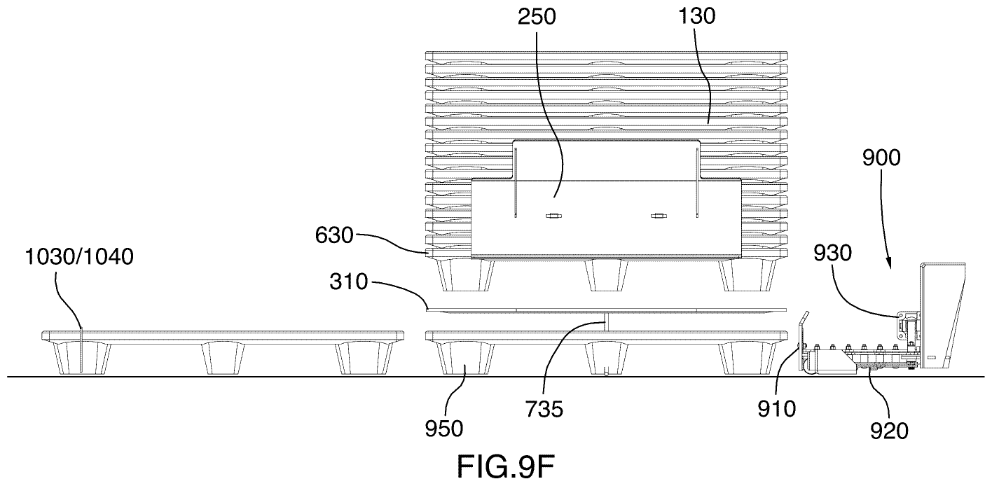

Referring to FIG. 7C, in an embodiment, a conveyor photo-eye 1030 with conveyor photo-eye beam 1040 is shown in use with the gravity conveyor 240. In another embodiment, the conveyor photo-eye 1030 and the conveyor photo-eye beam 1040 is shown in use with the indexer, as shown in FIGS. 9A-9F. The conveyor photo-eye 1030 is for detecting the presence of a pallet 100 and indicates that the conveyor is full or almost full. For the conveyor 240, when both the conveyor photo-eye 1030 and the dispensed photo-eye 730 are disrupted then the conveyor is full and operation of the nestable pallet dispenser is stopped. For the indexer 900, when both the conveyor photo-eye 1030 and the dispensed photo-eye 730 are disrupted then the conveyor is full and operation of the nestable pallet dispenser is stopped. When pallets are removed and the conveyor photo-eye 1030 or the dispensed photo-eye 730 are not disrupted, then dispensing is started again. The above embodiments allow for the dispensing of multiple pallets.

If, in an embodiment, the conveyor photo-eye 1030 is not included, then the dispensed photo-eye may control the start and stopping of the dispensing of the nestable pallet dispenser. This would allow for the dispensing of a single pallet.

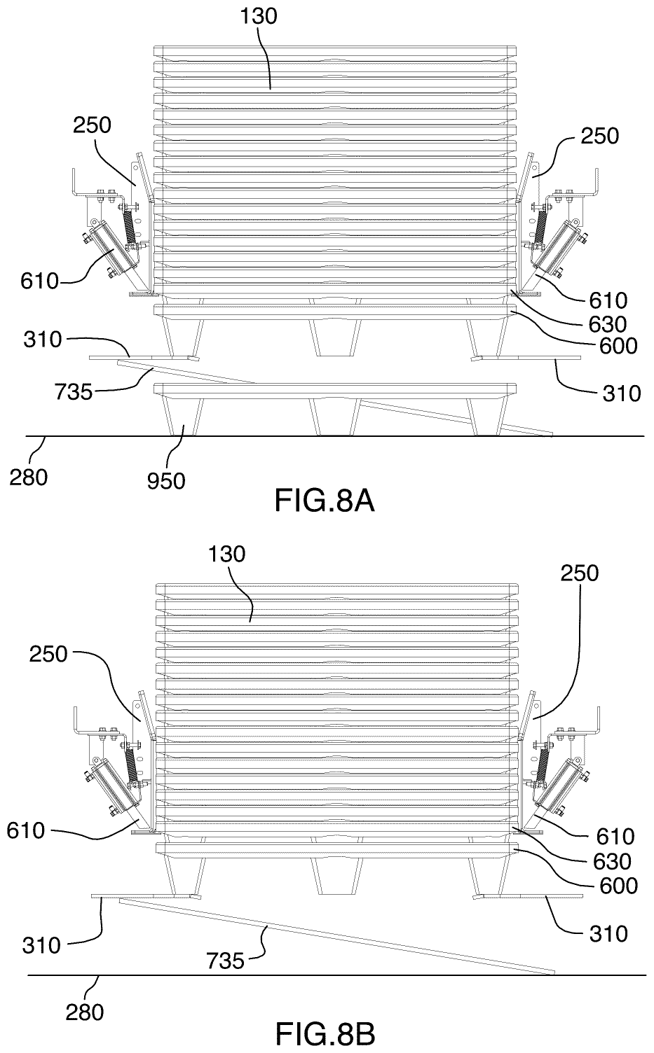

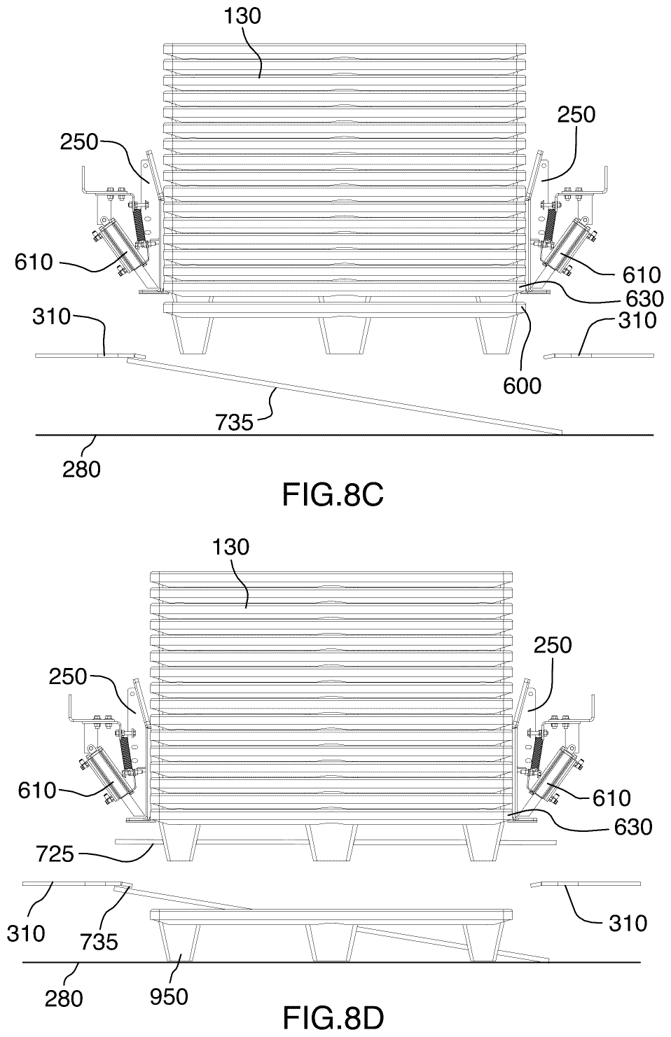

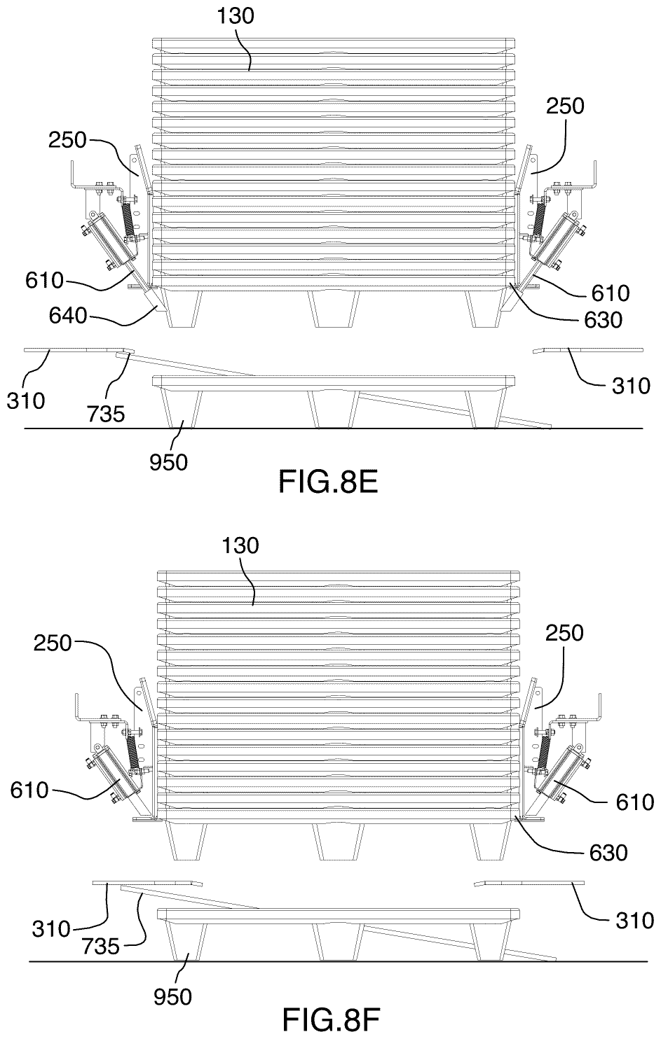

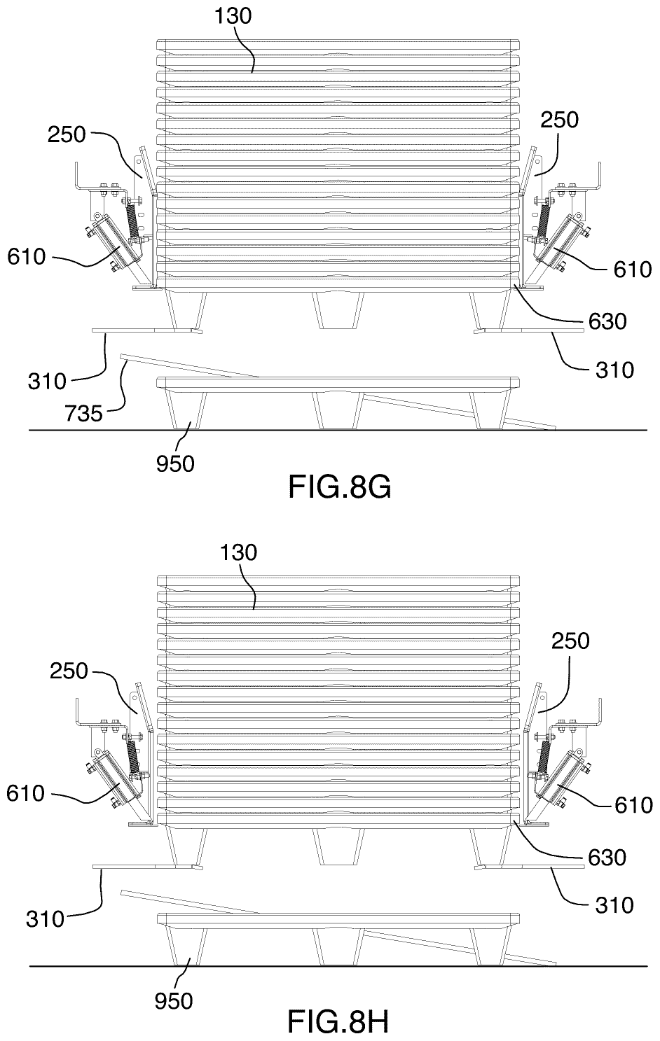

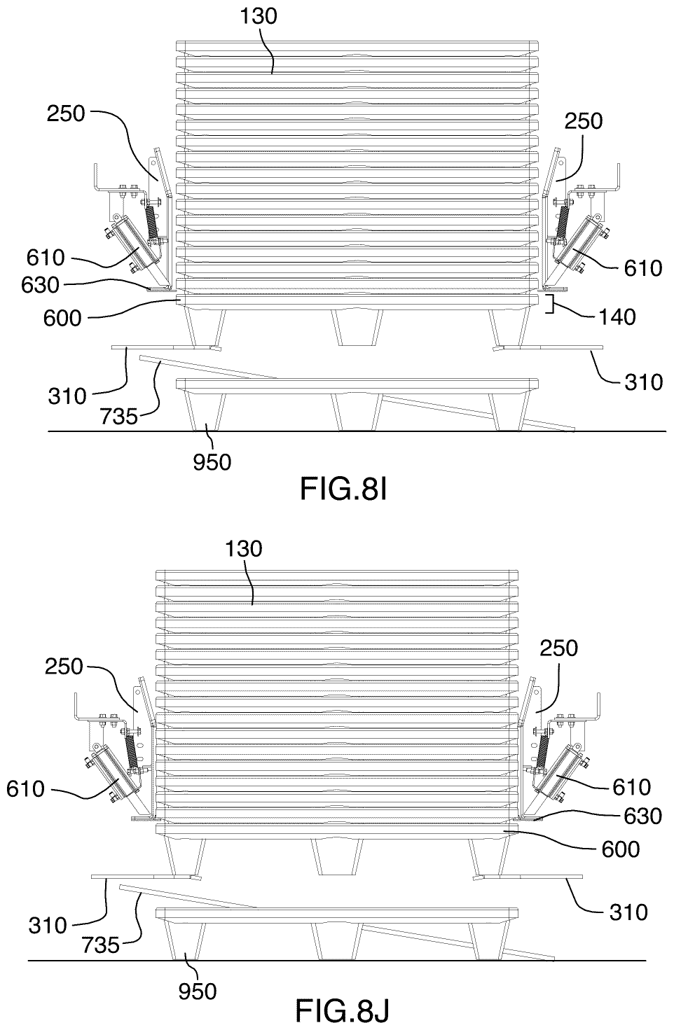

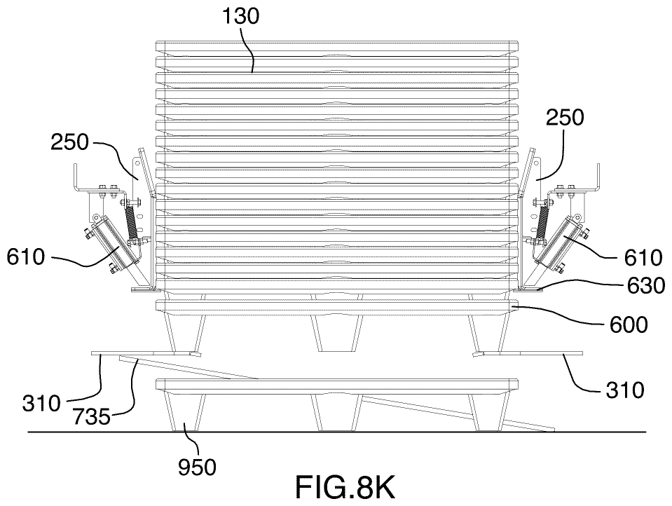

In operation, referring to FIGS. 8A-8K, the moveable support frame 300 and the bottom support plates 310 are in the pallet dispense support position, clamps 250 are clamped to the second bottommost pallet 630 and higher, with the bottommost pallet 600 resting on bottom support plates 310 in the extended support position. The dispensed photo-eye 730 detects the presence or absence of a dispensed pallet 950 on working surface 280. In FIG. 8A, dispensed photo-eye beam 735 detects the presence of a dispensed pallet 950.

The dispensed pallet 950 is then removed by a worker, e.g. using a pallet jack. In FIG. 8B, no pallet is detected on working surface 280 by dispensed photo-eye beam 735, bottom support plates 310 are moved into the retracted support position via plate pneumatic cylinders 320 as shown in FIG. 8C. Bottommost pallet 600 is then dispensed onto working surface 280 via the function of gravity as shown in FIG. 8D. Dispensed photo-eye beam 735 then detects the presence of the now dispensed pallet 950 (formerly bottommost pallet 600) on working surface 280. In response to the detected presence of the dispensed pallet 950, the stack 130 is held in place, waiting to dispense the next pallet.

As shown in FIG. 8E, in an embodiment, if dispensed photo-eye 730 fails to detect the presence of the dispensed pallet 950 on working surface 280, then ejectors 610 are activated and move to the extended position so that the ejector fingers 640 contact the deck 110 of the bottommost pallet 600 and forcibly assist in pushing bottommost pallet 600 onto working surface 280. In another embodiment, the bottom photo-eye 720 may still detect the presence of the bottommost pallet 600 and then trigger the ejectors 610. In another embodiment, the bottom photo-eye 720 may still detect the presence of the bottommost pallet 600 and the dispensed photo-eye 730 may not detect any pallet, and this would activate the ejectors 610. The ejectors 610 may be trigger more than one time, as programmed. Ejectors 610 are then deactivated and moved back into the retracted position.

In FIG. 8F to 8G, once the dispensed photo-eye 730 detects the dispensed pallet 950 on working surface 280, the bottom photo-eye 720 is clear, or both, then bottom support plates 310 are moved back into the extended position. Moveable support frame 300 then moves upwards into the stack support position, with the bottommost pallet 600 (former second bottommost pallet 630) resting upon bottom support plates 310.

In FIG. 8H to 8K, clamps 250 are then opened, and movable support frame 300 is lowered one nesting pitch 140 into the pallet support position. Clamps 250 are then closed and engage the second bottommost pallet 630 with bottommost pallet 600 resting on bottom support plates 310. Once the pallet stack 130 is clamped, the moveable support frame 300 is lowered between approximately 0.25 inches and approximately 1.5 inches, but preferably about 1 inch to the pallet dispense support position for relieving the stack pressure on the bottommost pallet 600. Bottommost pallet 600 is then ready to be dispensed according to the steps described above.

In an embodiment, referring to FIGS. 9A-9F, after dispensing, the dispensed pallets 950 are moved away from the dispensed position on the working surface 280 using an optional indexer 900 towards the front opening 308. Indexer 900 pushes the dispensed pallet 950 with a pusher plate 910 coupled to an extendable arm 920. Extendable arm 920 is extended and retracted using an indexer pneumatic cylinder 930.

As shown in FIG. 9D, the extendable arm 920 extends the full length of moveable frame 300 such that dispensed pallet 950 is completely removed from dispensed area under the nestable pallet dispenser 200 on the working surface 280. The extendable arm then retracts (FIG. 9E) such that a new bottommost pallet 600 may be dispensed into the working surface 280 (FIG. 9F).

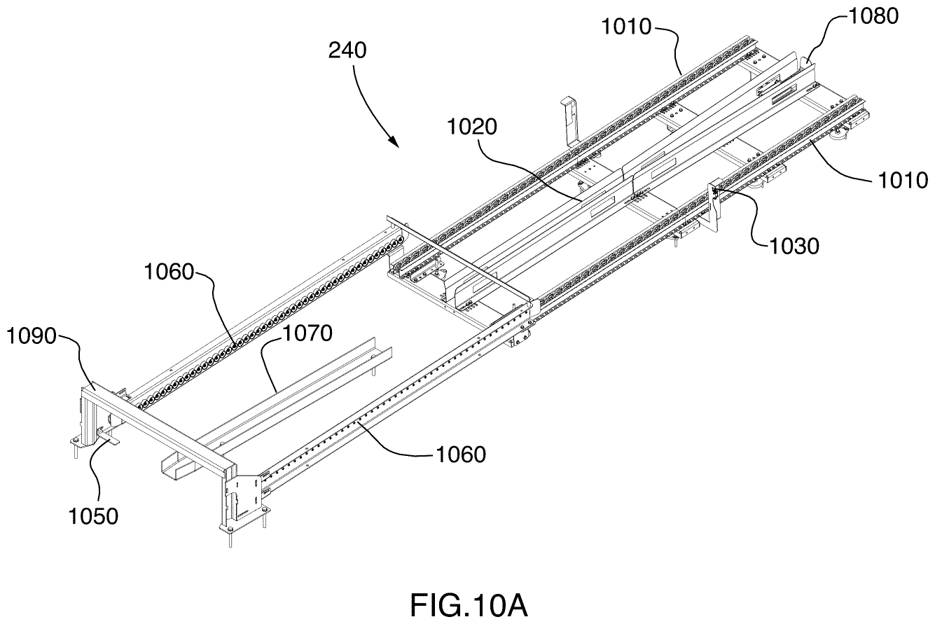

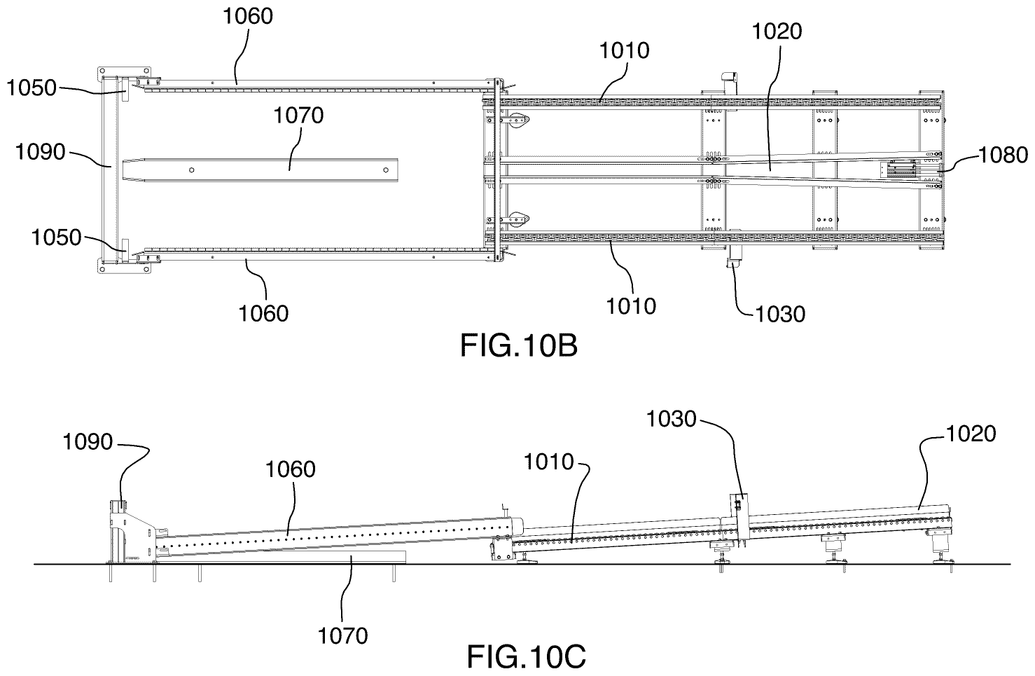

In another embodiment, referring to FIGS. 10A-10C, optional conveyor 240 may operate as a gravity conveyor 240 to move dispensed pallets 950 out of the dispensed area under the nestable pallet dispenser 200 on the working surface 280 and to store multiple dispensed pallets 950 for pickup. In this embodiment, as shown in FIG. 7B, the working surface 280 is the top surface of the gravity conveyor 240. A first end or first stage of conveyor 240 is formed from a pair of side rails 1010 and a center rail 1020. A conveyor photo-eye 1030 projects a conveyor photo-eye beam 1040 across conveyor 240 to detect the presence of pallets 100 or dispensed pallets 950 on conveyor 240. Bumper 1080 is for urging a dispensed pallet 950 towards the dispensing end.

A second stage or second end of conveyor 240 is formed from a pair of side rollers 1060 and an end rail 1070. The end of conveyor 240 is marked by a blocker 1090 and stopper 1050. The blocker 1090 is for blocking the incoming material handler 1300 to prevent damage to the dispenser 200, the conveyor 240, or both, while allowing the forklift arms 1310 access. The blocker 1090 is also sized appropriately that pallets may be retrieved and removed by the material handler 1300. The end rail 1070 may provide guidance for the forklift arms 1310. Side rails 1010, center rail 1020 and side rollers 1060 are positioned at an angle offset from horizontal to permit the pallets 100 to move along conveyor 240 via the force of gravity. In an embodiment the side rails and side rollers comprise conveyor wheels for reducing friction. In another embodiment the sides rails and side rollers may have a low friction coating for reducing friction.

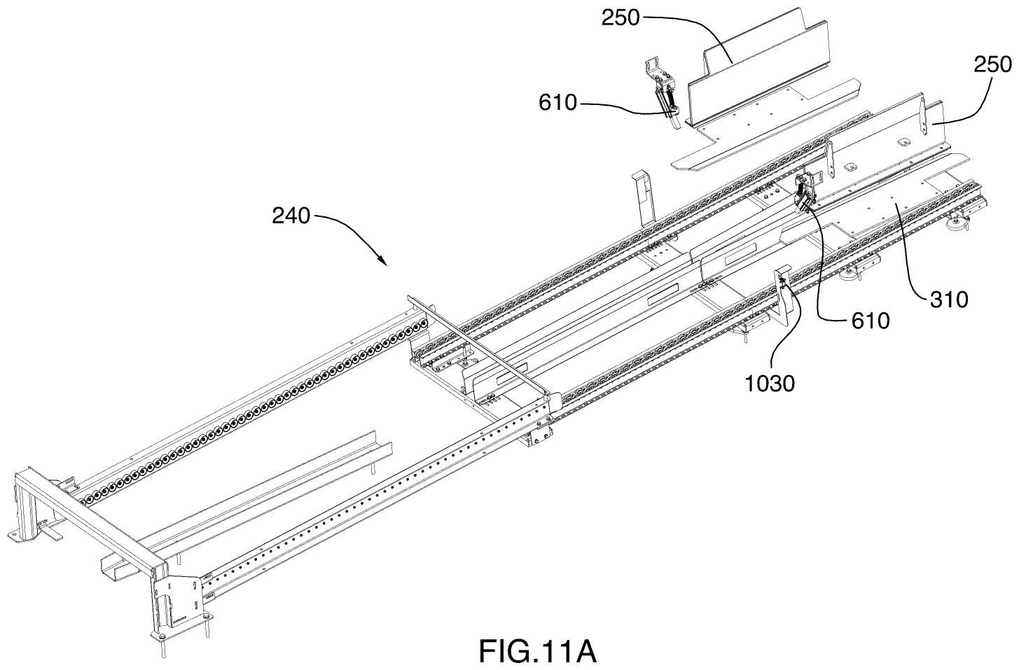

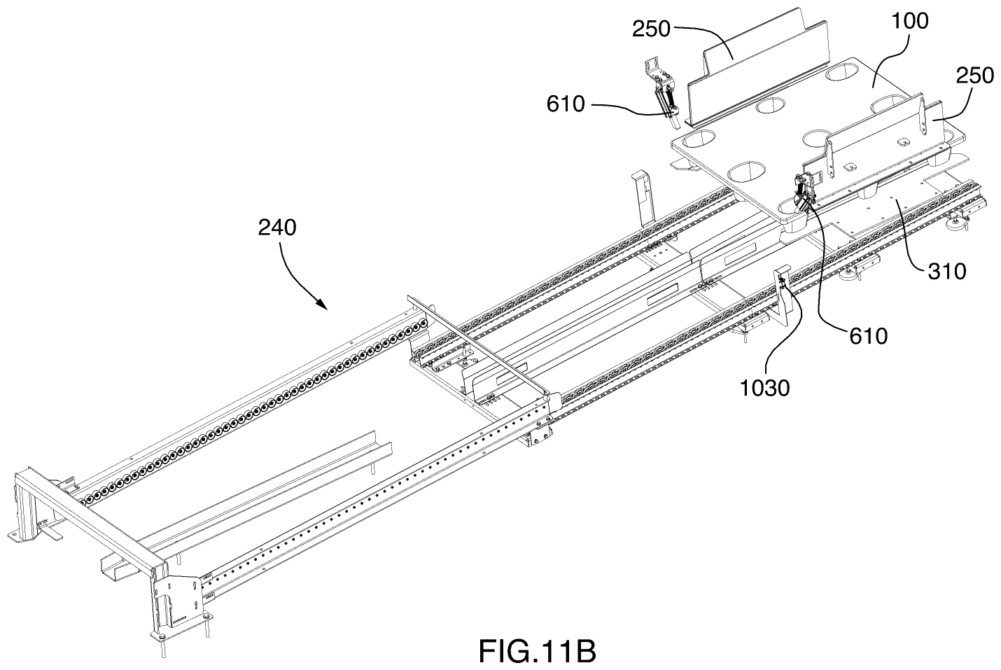

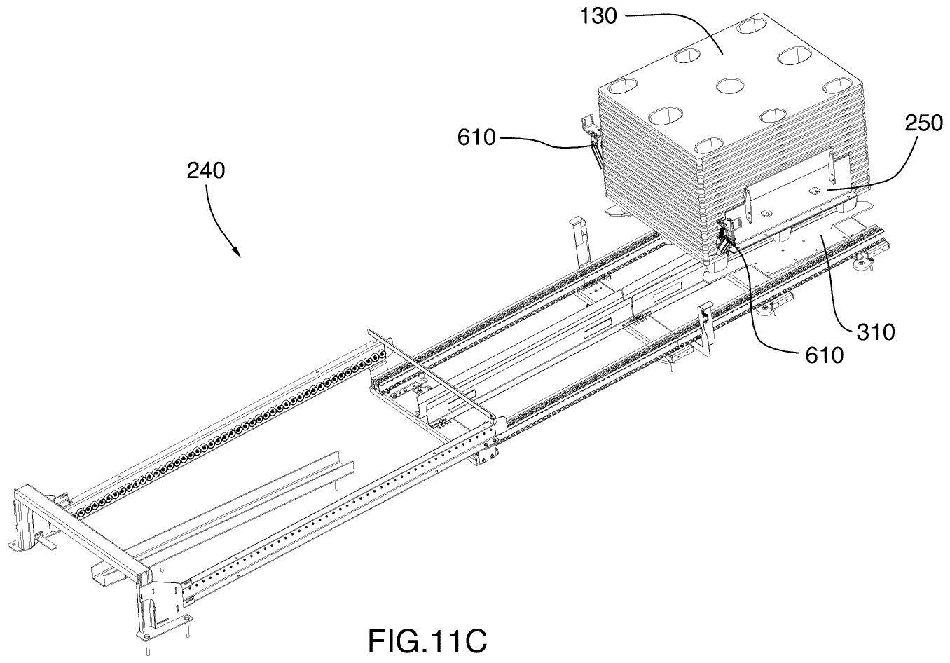

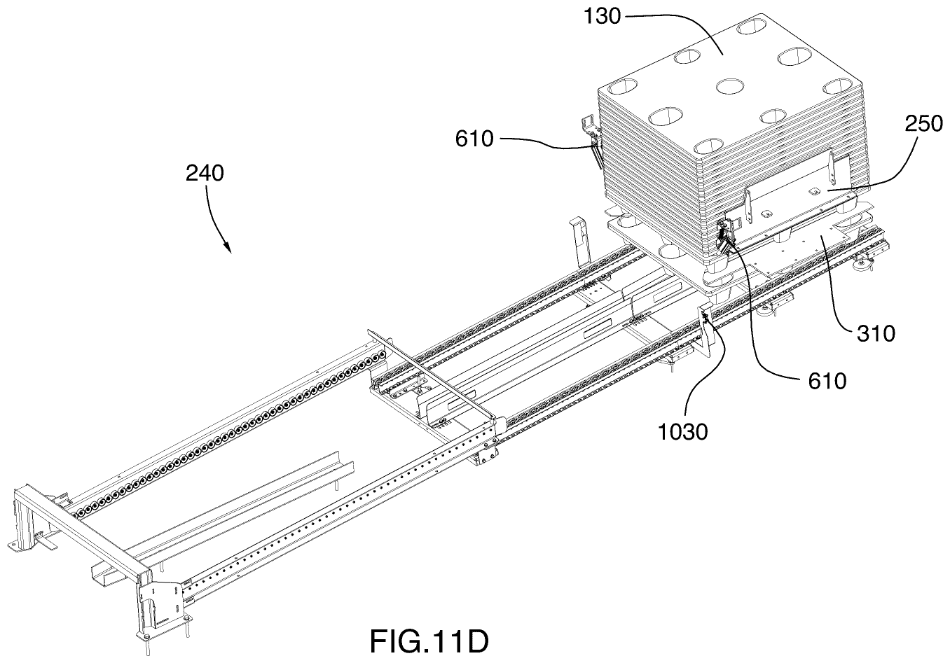

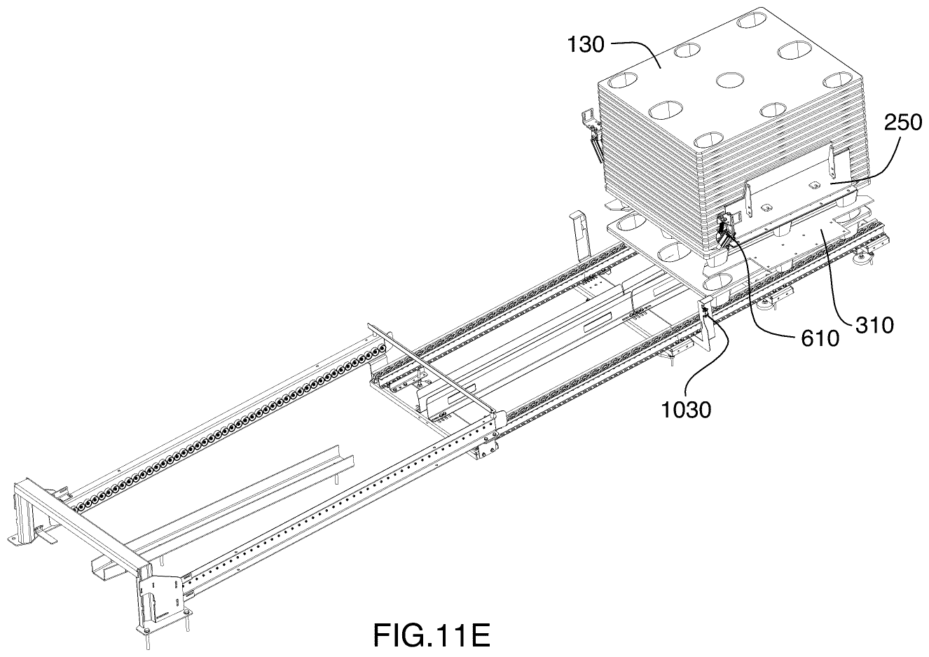

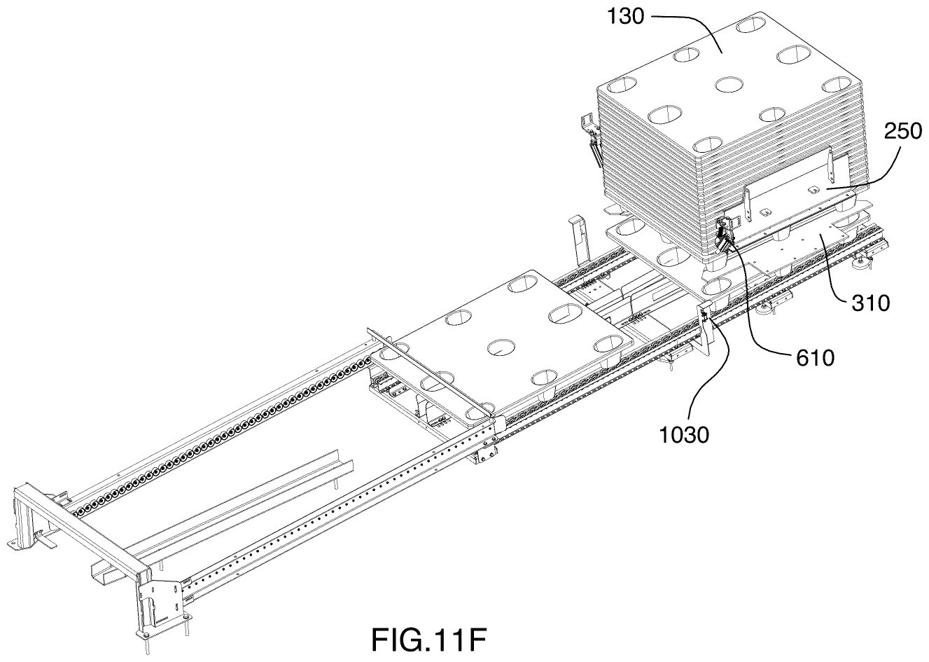

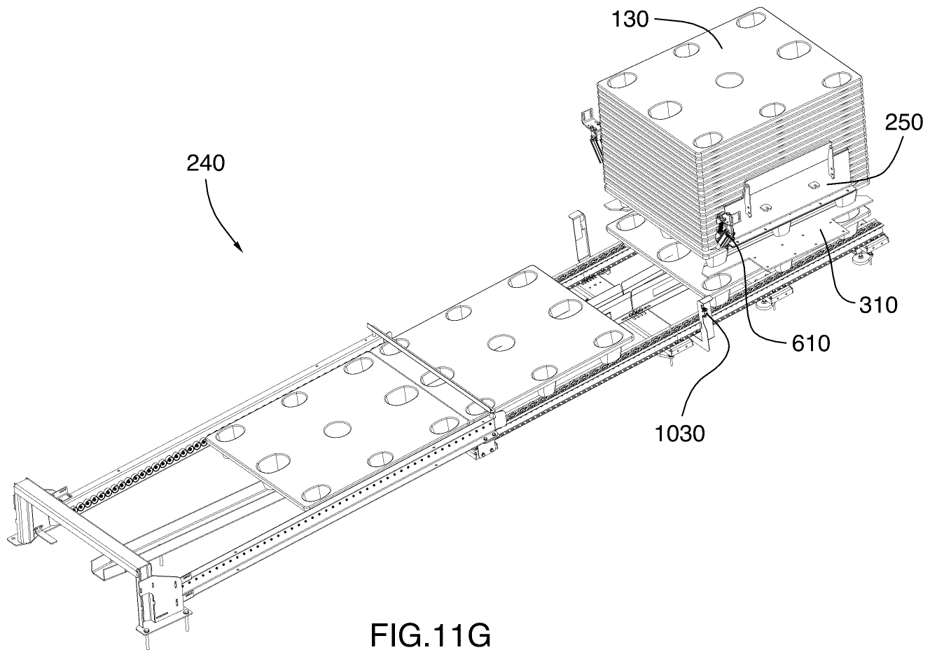

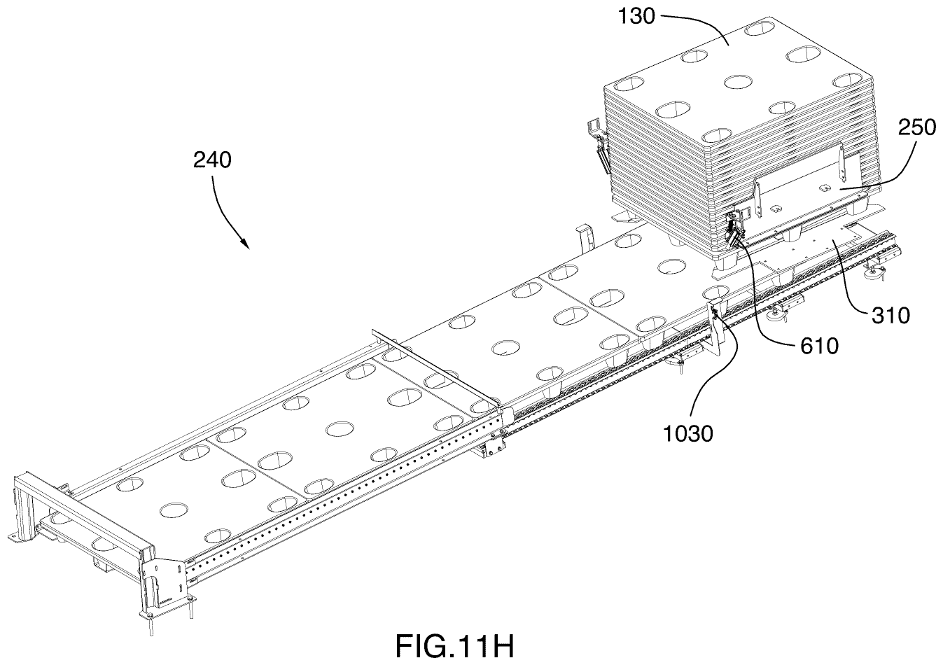

Referring to FIGS. 11A-11H, the legs 120 of pallet 100 rest upon the side rails 1010 and center rail 1020 once dispensed from nestable pallet dispenser 200. As pallet 100 passes or dispensed pallet 950 onto side rollers 1060, deck 110 rests upon side rollers 1060, and end rail 1070 engages the center legs 120 of pallet 100 to maintain alignment of the pallet 100 on conveyor 240. Pallet 100 or dispensed pallet 950 rolls out of working surface 280 and then moves along conveyor 240 via gravity until contacting another pallet 100, or stopper 1050 at the end of conveyor 240.

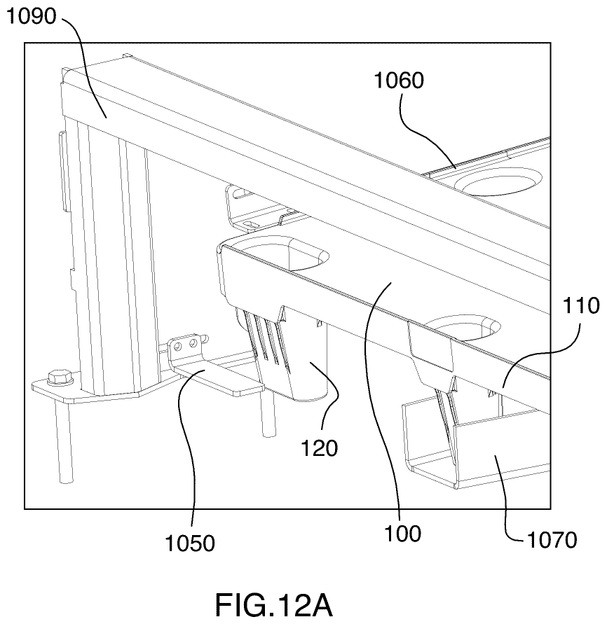

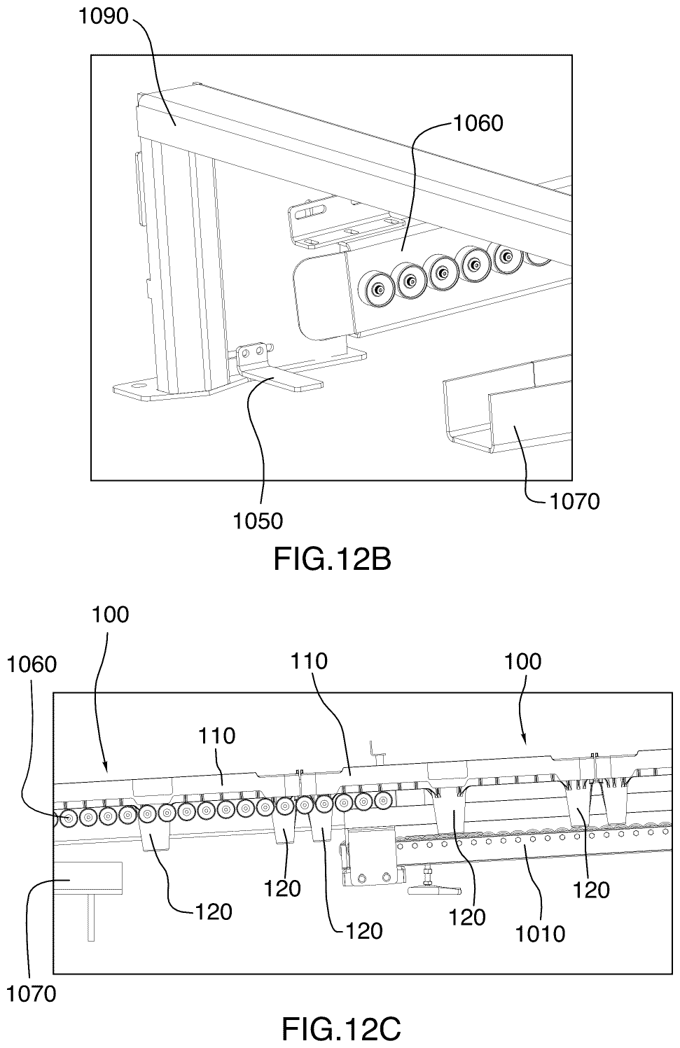

Referring to FIGS. 12A-12C, the leg 120 of pallet 100 contacts stopper 1050 to prevent pallet 100 from rolling off the end of conveyor 240. Blocker 1090 is positioned behind stopper 1050 and is raised to a height sufficient to allow pallet 100 to pass beneath blocker 1090 when lifted for removal. FIG. 12C shows details of the pallet 100 or dispensed pallet 950 is initially supported by legs 120 on side rails 1010, the center rail 1020, or both of the first stage. Then the dispensed pallet 950 is supported by bottom of the deck 110 by side rollers 1060 for allowing retrieval of the pallets 100 by the material handler 1300.

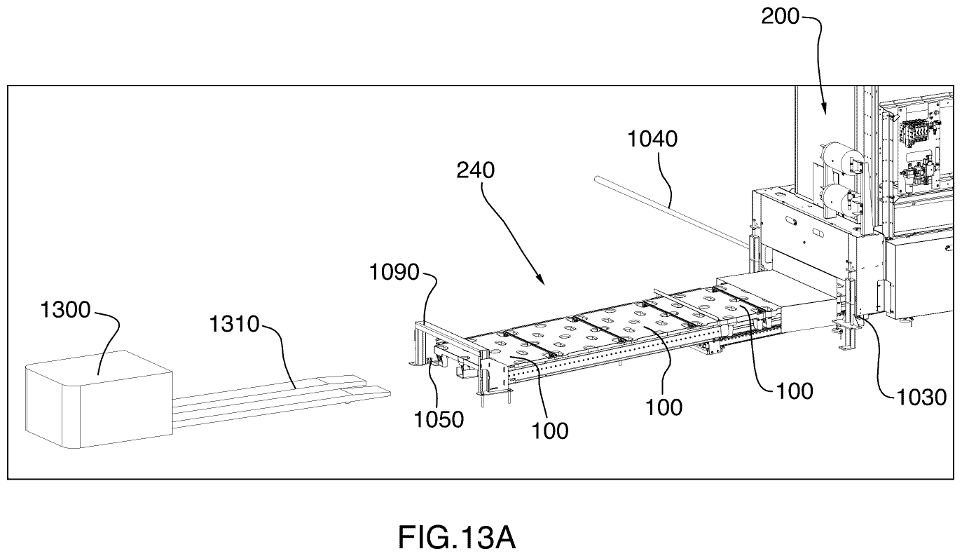

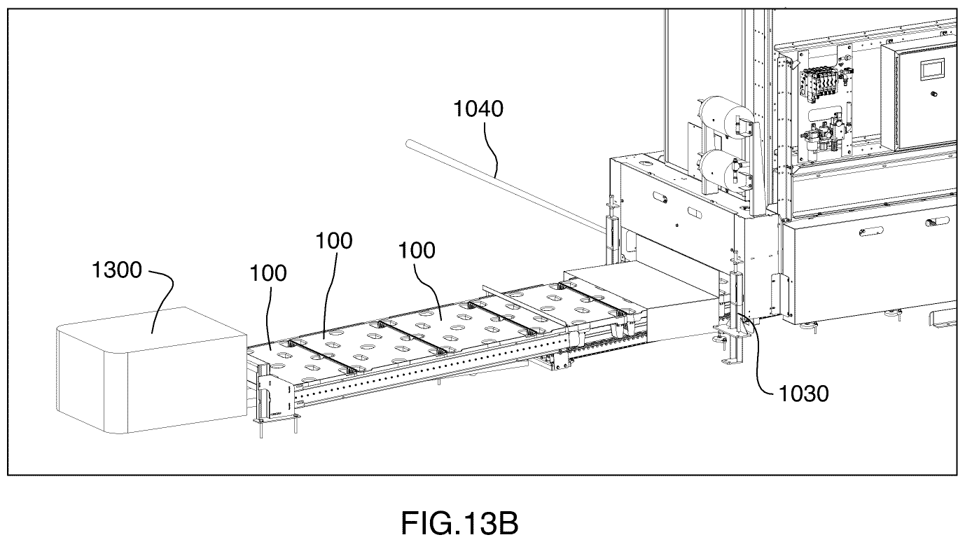

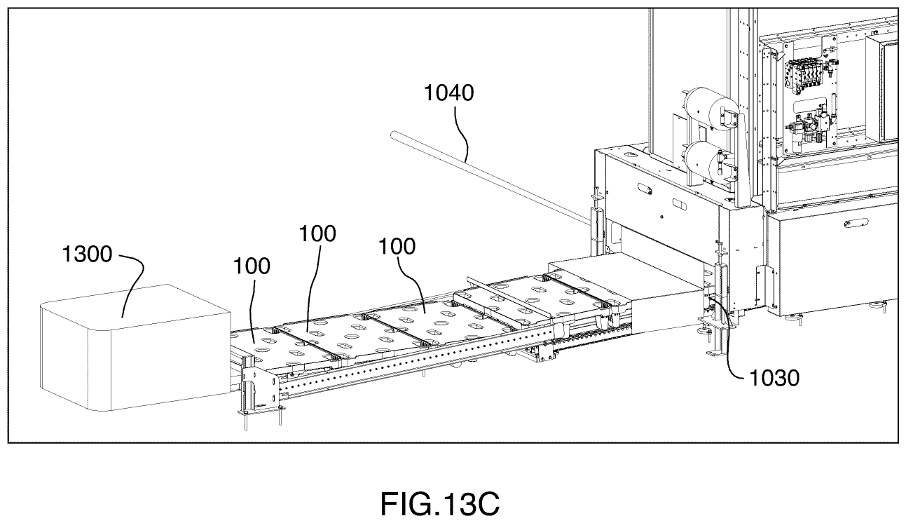

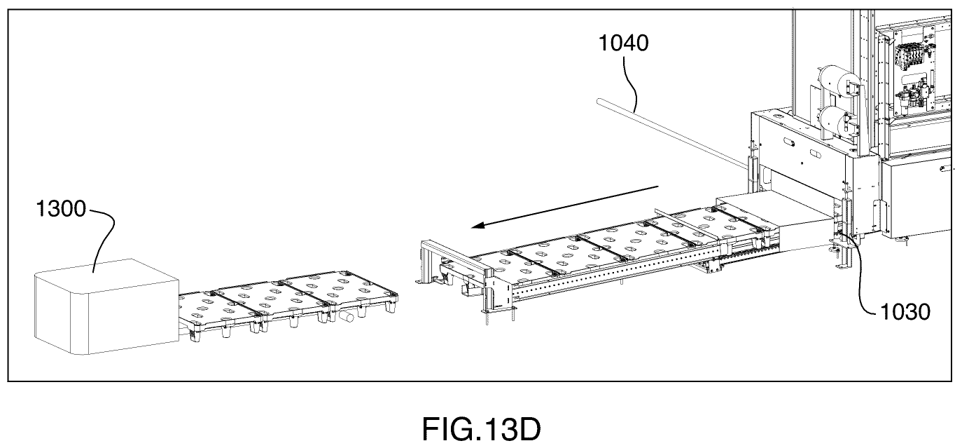

Pallets 100 are picked up from conveyor 240 coming out of opening 230 as shown in FIGS. 13A-13D. A material handler (e.g. a forklift, walkie rider, pallet jack, etc.) 1300 approaches conveyor 240 from the rear. Forklift arms 1310 extend outward, with the length of forklift arms 1310 determining the number of pallets that are to be picked up in a single load. As shown herein, three pallets 100 may be picked up at a time in a single load.

Material handler 1300 then drives forward until contacting blocker 1090 as shown in FIG. 13B. At this point, forklift arms 1310 extend under the pallets 100 that are to be picked up, three pallets 100 as shown. Forklift arms 1310 are then raised slightly, as shown in FIG. 13C, to disengage pallets 100 from conveyor 240.

Material handler 1300 then drives in reverse until all pallets 100 are clear of conveyor 240 and blocker 1090, as shown in FIG. 13D. Additional pallets 100 may then be dispensed by the nestable pallet dispenser 200 and roll forward onto conveyor 240 to prepare for another load of pallets 100 to be picked up.

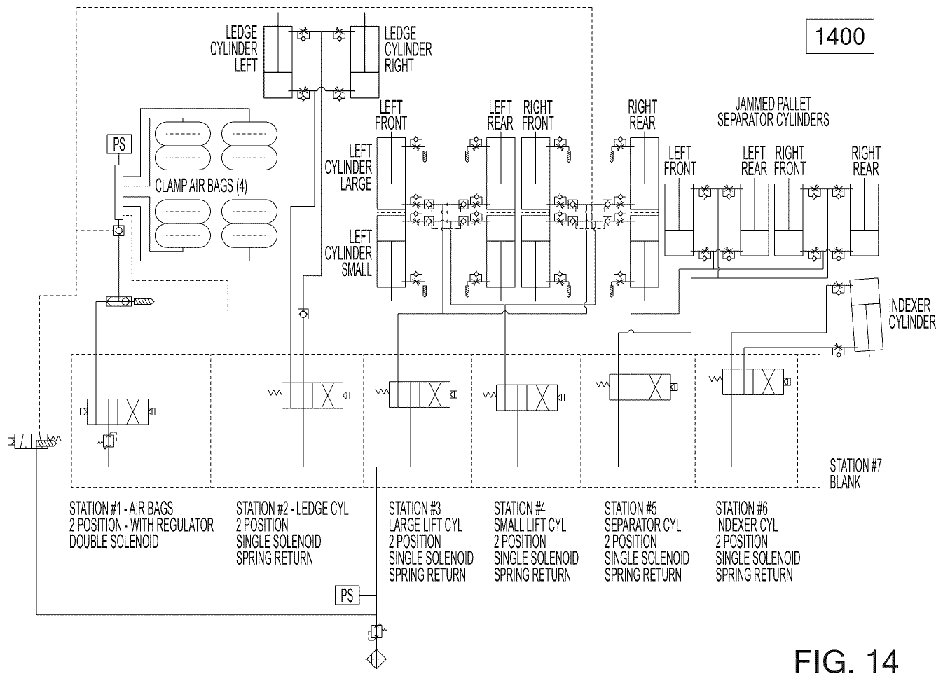

FIG. 14 shows an embodiment of a pneumatic circuit for the nestable pallet dispenser 200. In an embodiment, the pneumatic circuit is controlled by a computer 1400, programmable logic controller (PLC) 1400 or both. In another embodiment, the nestable pallet dispenser is controlled by the computer 1400, PLC 1400, or both. The connections between the computer 1400 to the pneumatic circuit, the nestable pallet dispenser or both are not shown. The connections between the PLC 1400 to the pneumatic circuit, the nestable pallet dispenser or both are not shown. In an embodiment, the nestable pallet dispenser uses an electrical connection and 5 cubic feet per minute (CFM) of 80 pounds per square inch (PSI) compressed air.

Although the embodiments described herein have been shown for use with nestable full-size pallets, they could be used with nestable half-pallets with minor modifications.

It should also be noted that the steps described in the method of use may be carried out in alternative orders according to user preference. The use of “step of” should not be interpreted as “step for”, in the claims herein and is not intended to invoke any statutory provisions of interpretation. It should also be noted that, under appropriate circumstances, considering such issues as design preference, user preferences, marketing preferences, cost, structural requirements, available materials, technological advances, etc., other methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A nestable pallet dispenser for a stack of nestable pallets, comprising:
a frame defining a holding area for the stack of nestable pallets;
a pair of pallet clamps mounted to the frame on opposing sides, operable in an open clamp position and a closed clamp position, and for clamping the stack of nestable pallets in the closed clamp position;
a movable support frame movably connected to the frame; and
a pair of retractable bottom support plates mounted to the movable frame on opposing sides and below the pair of pallets clamps, operable in an extended support position and a retracted support position, and for supporting a nestable pallet from the stack of nestable pallets in the extended support position.

2. The nestable pallet dispenser of claim 1, further comprising:
powered cylinders for movably connecting the movable support frame with the frame, and the movable support frame is movable to a stack support position, a pallet support position, and a dispense support position.

3. The nestable pallet dispenser of claim 2, further comprising:
ejectors mounted to the frame adjacent to and on each side of the pair of pallet clamps, operable in an extended ejector position and a retracted ejector position, and for urging a bottom nestable pallet away from the stack of nestable pallets in the extended ejector position.

4. The nestable pallet dispenser of claim 1, wherein:
the pallet support position of the movable frame corresponds with the pair of pallet clamps clamping in the closed clamp position at least a second from the bottom nestable pallet of the nestable pallet stack, and the bottom nestable pallet of the pallet stack is not clamped.

5. The nestable pallet dispenser of claim 3, wherein:
each of the powered cylinders comprise a first pneumatic cylinder and a second pneumatic cylinder fixedly connected and arranged to extend away from each other.

6. The nestable pallet dispenser of claim 5, wherein:
the stack support position is defined by extension of the first pneumatic cylinder and extension of the second pneumatic cylinder;
the pallet support position is defined by the retraction of the first pneumatic cylinder and extension of the second pneumatic cylinder; and
the dispense support position is defined by the retraction of the first pneumatic cylinder and retraction of the second pneumatic cylinder.

7. The nestable pallet dispenser of claim 1, wherein:
the movable support frame is u-shaped with a left side, a right side, and a rear side, and there are four powered cylinders located at corners of the movable support frame for movably connecting the movable support frame to the frame.

8. The nestable pallet dispenser of claim 1, further comprising:
a metallic finger attached to the movable support frame for indicating the support position of the movable frame; and
magnetic proximity sensors on the frame for detecting the metallic finger for determining the support position of the movable frame.

9. The nestable pallet dispenser of claim 8, wherein:
the pallet support position is a nesting pitch below the stack support position, and the dispense support position is about 1 inch below the pallet support position.

10. The nestable pallet dispenser of claim 9, wherein:
each of the pair of bottom support plates comprise a support plate connected to a linear rail and a plate powered cylinder, the linear rail and the plate powered cylinder mounted to the movable support frame.

11. The nestable pallet dispenser of claim 10, wherein:
the extended support position of the bottom support plate is caused by extension of the plate powered cylinder; and
the retracted support position of the bottom support plate is caused by retraction of the plate powered cylinder.

12. The nestable pallet dispenser of claim 3 wherein:
each of the ejectors ejects in the extended ejector position by pushing on a deck of the bottom nestable pallet.

13. The nestable pallet dispenser of claim 12, wherein:
each ejector comprises an ejector powered cylinder; and
the extended ejector position is caused by extension of the ejector powered cylinder, and the retracted ejector position is caused by retraction of the ejector powered cylinder.

14. The nestable pallet dispenser of claim 13, wherein:
each of the pair of pallet clamps comprise a plate, a linkage, and a clamp powered cylinder, the plate connected through the linkage to the frame, and the plate connected through the clamp powered cylinder to the frame.

15. The nestable pallet dispenser of claim 14, wherein:
the open clamp position of the pair of pallet clamps is caused by retraction of the clamp powered cylinder; and
the closed clamp position of the pair of pallet clamps is caused by extension of the clamp powered cylinder.

16. The nestable pallet dispenser of claim 15, further comprising:
a pallet dispensed area is defined as underneath the nestable pallet dispenser and below the holding area.

17. The nestable pallet dispenser of claim 16, further comprising:
a stack photo-eye for detecting the stack of nestable pallets;
a bottom photo-eye for detecting the bottom nestable pallet; and
a dispensed photo-eye for detecting a dispensed pallet in the pallet dispensed area.

18. The nestable pallet dispenser of claim 17, wherein:
the nestable pallet dispenser is set to a support the pallet stack configuration, comprising:
the pair of retractable bottom support plates are in the extended support position and the movable support frame is at the stack support position;
the pair of pallet clamps are in the open clamp position; and
the ejectors are in the retracted ejector position.

19. The nestable pallet dispenser of claim 18, wherein:
the nestable pallet dispenser is set to a preparing to dispense configuration, comprising:
the pair of retractable bottom support plates are in the extended support position and the movable support frame is at the pallet support position;
the pair of pallet clamps are in the closed clamp position; and
the ejectors are in the retracted ejector position.

20. The nestable pallet dispenser of claim 19, wherein:
the nestable pallet dispenser is set to a dispense configuration, comprising:
the pair of retractable bottom support plates are in the retracted support position and the movable support frame is at the dispense support position;
the pair of pallet clamps are in the closed clamp position; and
the ejectors are in the retracted ejector position.

21. The nestable pallet dispenser of claim 20, wherein:
when the nestable pallet dispenser is set to the dispense configuration, and the bottom photo-eye detects a presence of the bottom nestable pallet, then cycling the ejectors through the extended ejector position and the retracted ejector position, for ejecting and dispensing the bottom nestable pallet into the pallet dispensed area.

22. The nestable pallet dispenser of claim 21, further comprising:
a conveyor photo-eye adjacent to the pallet dispensed area working with the dispensed photo-eye for starting and stopping operation of the nestable pallet dispenser.

23. The nestable pallet dispenser of claim 2 wherein the powered cylinder is a pneumatic cylinder, a hydraulic cylinder, or an electric cylinder.

24. A method for dispensing nestable pallets, comprising:
clamping by a pair of pallet clamps in a closed clamp position a penultimate bottom pallet, wherein a bottom pallet is not clamped, the penultimate bottom pallet and the bottom pallet in a stack of nestable pallets; and
supporting the bottom pallet on a pair of bottom support plates in an extended support position and a movable support frame in a pallet support position.

25. The method of claim 24, further comprising:
lowering the movable support frame to a dispense support position for lowering the bottom support plates for reducing stack pressure between the bottom pallet and the penultimate pallet; and
detecting with a dispensed sensor that there is no pallet on a working surface.

26. The method of claim 25, further comprising:
retracting the bottom support plate to a retracted support position for letting the bottom pallet fall to the working surface;
detecting with the dispensed sensor if the bottom pallet has fallen to the working surface;
if the dispensed sensor does not detect the bottom pallet on the working surface, then:
activating ejectors to an extended ejector position for pushing the bottom pallet onto the working surface.

27. The method of claim 26, further comprising:
detecting with the dispensed sensor that the bottom pallet is on the working surface;
extending the bottom support plates to the supported position; and
raising the movable support frame to the stack support position for supporting the penultimate bottom pallet which is now the bottom pallet.

28. The method of claim 27, wherein the detecting step further comprises:
detecting with the dispensed sensor that the bottom pallet is on the working surface, and, detecting with a bottom sensor that the bottom pallet has fallen.

29. The method of claim 28, further comprising:
retracting the clamps to an open clamp position;
supporting the stack of nestable pallets on the bottom support plates; and
lowering the movable support frame to the pallet support position.

30. The method of claim 29, further comprising:
detecting with the dispensed sensor that the bottom pallet is on the working surface, and, detecting with a conveyor sensor that a dispensed pallet is blocking the conveyor sensor, then, pausing the dispensing.

31. The method of claim 30, wherein the activating ejectors step further comprises:
the ejectors are activated more than once; and
a fault is triggered if the bottom sensor and the dispensed sensor are both blocked.

32. The method of claim 30, wherein:
a distance between the stack support position and pallet support position is one nesting pitch of the stack of nestable pallets.

33. The method of claim 25, wherein the dispensed sensor is a photo-eye.

34. A gravity conveyor for pallets, comprising:
a first end for receiving a pallet with legs and a deck, comprising;
a support rail for slidably supporting a bottom of the legs;
a guide rail for receiving a subset of the legs and guiding the pallet along a length of the first end of the gravity conveyor towards a second end;
a support frame for connecting the first end to the second end;
the second end for dispensing the pallet from a dispensing end, the dispensing end opposite the first end, comprising:
a pair of upper guide rails for slidably supporting bottom edges of the deck and guiding the pallet along the length of the gravity conveyor toward the dispensing end; and
a stop at the dispensing end for stopping the pallet from sliding by blocking one of the legs.

35. The conveyor of claim 34, wherein the support rail is a pair of support rails that run parallel to the guide rail, and the pair of support rails are on both sides of the guide rail.

36. The conveyor of claim 35, wherein the guide rail is a pair of parallel walls spaced apart to receive the subset of the legs between the pair of parallel walls.

37. The conveyor of claim 36, wherein the support rail and the pair of upper guide rails have an upper surface with a low friction coating, rollers, or both.

38. The conveyor of claim 34, wherein the first end and the second end are each sloped at an angle for conveying the pallet from the first end to the dispensing end by gravity.

39. The conveyor of claim 38, wherein, the first end and the second end are each sloped at a same angle.

40. The conveyor of claim 39, wherein, the conveyor further comprises:
a set of supports attached to the first end, the second end, or both for supporting the first end and the second at the angle.

41. The conveyor of claim 34, wherein, the conveyor is configured to support four to seven pallets.

42. The conveyor of claim 34, further comprising:
a blocker placed perpendicularly to the upper guide rails and at the dispensing end for preventing collision with the pallets, the conveyor, or both.

43. The conveyor of claim 42, further wherein:
the pallet is supported by the bottom of the legs by the support rail of the first end, and transitions to the pallet being supported by the bottom edges of the deck by the pair of upper guide rails of the second end.

44. The conveyor of claim 34, further comprising:
a bumper on the first end, opposite the dispensing end, for urging the pallet towards the dispensing end.
